(19) United States
(12) Patent Application Publication
(10) Pub. No.: US 2021/0264799 A1
(43) Pub. Date: Aug. 26, 2021

(54) UAVS, INCLUDING MULTI-PROCESSOR UAVS WITH SECURED PARAMETERS, AND ASSOCIATED SYSTEMS, DEVICES, AND METHODS

(71) Applicant: Skytask, Inc., Niwot, CO (US)

(72) Inventors: David Christopher Belt, Fort Collins, CO (US); Paul Albert Ragland, Niwot, CO (US)

(21) Appl. No.: 17/179,871

(22) Filed: Feb. 19, 2021

Related U.S. Application Data
(60) Provisional application No. 62/978,872, filed on Feb. 20, 2020.
(60) Provisional application No. 62/980,522, filed on Feb. 24, 2020.

(51) Int. Cl. G08G 5/00; B60W 60/00; G05D 1/00; B64C 39/02

(52) U.S. Cl. CPC G08G 5/0069; B60W 60/00259; B64C 2201/141; G05D 1/0088; B64C 39/024; B60W 60/007

(57) ABSTRACT

Unmanned aerial vehicles (UAVs), including multi-processor UAVs with secured parameters, and associated systems, devices, and methods are disclosed herein. In one embodiment, a UAV includes a flight controller configured to control flight operations of the UAV based at least in part on system parameters provided to the UAV. The UAV can additionally include an oversight processor configured to (i) monitor operations of the flight controller and (ii) intercede when the oversight processor determines the flight controller is operating in violation of the system parameters. In some embodiments, the system parameters are secured (e.g., digitally signed and/or encrypted) and provided to the UAV. In these and other embodiments, the UAV is configured to verify the secure systems parameters and/or to autonomously execute a flight plan after verifying the system parameters. In some embodiments, the system parameters define an operational envelope specifying airspace to which autonomous flight of the UAV is constrained.

### CROSS-REFERENCE TO RELATED APPLICATIONS

This application claims the benefit of U.S. Provisional Patent Application No. 62/978,872, filed Feb. 20, 2020, and of U.S. Provisional Patent Application No. 62/980,522, filed Feb. 24, 2020, each of which is incorporated by reference herein in its entirety.

This application is related to U.S. patent application Ser. No. 17/179,970, which (i) was filed concurrently herewith on Feb. 19, 2021, (ii) is titled “UAV SYSTEMS, INCLUDING AUTONOMOUS UAV OPERATIONAL CONTAINMENT SYSTEMS, AND ASSOCIATED SYSTEMS, DEVICES, AND METHODS,” and (iii) is incorporated by reference herein in its entirety.

### TECHNICAL FIELD

The present disclosure generally relates to unmanned aerial vehicles (UAVs). In particular, the present technology relates to UAVs, including multi-processor UAVs with secured parameters, and associated systems, devices, and methods.

### BACKGROUND

A UAV (otherwise known as a drone or an uncrewed aerial vehicle) is an aircraft that lacks a human pilot onboard. UAVs are often used in logistics operations (e.g. to deliver cargo); in civil or commercial settings (e.g., to capture aerial photographs, collect data, etc.); and/or in combat or reconnaissance operations. UAVs are also used in other settings, such as in recreational activities.

Commonly, UAVs are part of systems that also include ground-based controllers in communication with a corresponding UAV. In these systems, the controllers are often operated by a human such that the UAV is flown under full or partial control by the human. Additionally, or alternatively, the ground-based controller may be fully or partially operated without a human, or a UAV might include a controller (e.g., an autopilot) onboard, thereby enabling the UAV to fly with various degrees of autonomy.

UAVs can threaten airspace security in numerous ways, including intentional or unintentional (a) collisions or interference with other aircraft or objects and/or (b) flights over sensitive (e.g., confidential) areas or within restricted airspace. Therefore, many UAVs are subject to governmental regulations. In the United States, UAVs are subject to regulations defined by the Federal Aviation Administration (FAA). For example, the FAA requires registration of UAVs that weigh above 250 grams and defines airspace within which UAVs are restricted from flying (e.g., typically airspace at altitudes of approximately 122 meters or higher).

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure. The drawings should not be taken to limit the disclosure to the specific embodiments depicted, but are for explanation and understanding only.

FIG. 1A is a partially schematic representation (a) of a UAV operational containment system configured in accordance with various embodiments of the present technology and (b) of an environment in which the UAV operational containment system operates.

FIG. 1B is a partially schematic diagram of an example site of operation at which a UAV operational containment system of the present technology can be employed.

FIG. 2 is a block diagram of a flight manager in a UAV operational containment system, configured in accordance with various embodiments of the present technology.

FIG. 3 is a block diagram of a multi-processor UAV configured in accordance with various embodiments of the present technology.

FIG. 4 is a block diagram of a control tower in a UAV operational containment system, configured in accordance with various embodiments of the present technology.

FIG. 5 is a block diagram of a navigation beacon in a UAV operational containment system, configured in accordance with various embodiments of the present technology.

FIG. 6 is a partially schematic representation of a UAV inspection system in a UAV operational containment system, configured in accordance with various embodiments of the present technology.

FIG. 7 is a flow diagram illustrating a method of defining and securing system parameters for a multi-processor UAV, in accordance with various embodiments of the present technology.

FIG. 8 is partially schematic diagram of a user interface illustrating example system parameters for a site of operation, in accordance with various embodiments of the present technology.

FIG. 9 is a block diagram of a public key infrastructure management architecture and of a payload key configured in accordance with various embodiments of the present technology.

FIG. 10 is a partially schematic representation of shared memory media storing a secured system parameters package, in accordance with various embodiments of the present technology.

FIGS. 11A and 11B are flow diagrams illustrating methods of verifying system parameters provided to a multi-processor UAV, in accordance with various embodiments of the present technology.

FIG. 12 is a flow diagram illustrating a method of executing a flight plan using a multi-processor UAV, in accordance with various embodiments of the present technology.

### DETAILED DESCRIPTION

### A. Overview

As discussed above, UAVs can threaten airspace security in numerous ways, including intentional or unintentional (a) collisions or interference with other aircraft or objects or (b) flights over sensitive areas or within restricted airspace (e.g., for surveillance purposes). UAV geo-fencing technology included in some UAV technologies, is designed to combat this threat by preventing the UAV from passing into or out of a pre-defined geographic space. The primary use for this technology is the enforcement of regulatory (e.g., FAA) airspace rules and preventing the UAV from entering space for which it is not authorized.

Most geo-fence deployments are software implementations on the UAV itself. Thus, the UAV is configured to stop the aircraft when it determines it has reached a geo-fence boundary and to hover until provided another direction from the pilot-in-command. But these software geo-fencing implementations are vulnerable to hack and only work in the event the UAV's localization system hasn't failed or malfunctioned. Thus, the UAV cannot be trusted as a standalone entity. Indeed, most UAV manufacturers state that geofencing technology is for pilot-in-command notification purposes only, thereby implying that the UAV is not a trusted device.

To address these concerns, the inventors have developed a multi-processor UAV that (a) can be entrusted to enforce an operational envelope defined for and provided to the UAV and (b) can operate in the field (e.g., in beyond visual line of site (BVLOS) settings) without being hacked and/or without human control or intervention. In some embodiments, the UAV includes a main processor or controller (e.g., a flight controller) and an oversight processor or controller. In these and other embodiments, the multi-processor UAV can be in communication with a UAV operational containment system (e.g., as part of the UAV operational containment system or as a standalone entity merely in communication with the UAV operational containment system). The UAV operational containment system can be used to define various system parameters for the UAV, such as operational envelope parameters for the UAV. The operational envelope parameters can define an operational envelope for the UAV. The operational envelope can specify airspace at a site of operation in which the UAV is permitted to fly. Stated another way, the operational envelope can specify airspace at the site of operation to which (e.g., autonomous) operation of the UAV is bound.

In some embodiments, the UAV operational containment system can be used to (i) secure (e.g., digitally sign and/or encrypt) the system parameters, and/or (ii) provide the system parameters to the UAV. The system can secure the system parameters in such a way that only a specific UAV and/or a specific controller or processor (e.g., the flight controller or the oversight processor) of the UAV can decrypt, verify, and/or use the system parameters. This can increase the likelihood that the UAV is provided with correct system parameters for the specific UAV, as well as system parameters that have not been tampered with or corrupted. The secured system parameters can be stored to memory media and/or provided to both the flight controller and the oversight processor of the UAV. For example, the secured system parameters can be stored to a memory media that is shared between (e.g., accessible by both) the flight controller and the oversight processor of the UAV, such as over a shared memory interface of the UAV.

In operation, redundant localization systems of the UAV and redundant techniques for continuously monitoring a position of the UAV in relation to an operational envelope defined by secured system parameters (e.g., secured operational envelope parameters), increase the likelihood that the UAV will remain safe and within the operational envelope during (e.g., autonomous) flight operations. For example, the UAV can include multiple localization systems. The multiple localization systems can provide back-up in the event that one of the localization systems fails, malfunctions, or is otherwise compromised (e.g., hacked). Additionally, or alternatively, the flight controller of the UAV can serve as the main processor for the UAV and execute most of the decision making of the UAV during flight. The oversight processor of the UAV can (a) oversee operation of the flight controller by independently analyzing data collected by and/or provided to the UAV, and (b) intercede when it detects that the UAV has or is about to violate the operational envelope. The multiple processors therefore increase the likelihood for safely operating the UAV within the operational envelope even in the event the flight controller fails, malfunctions, or is otherwise compromised (e.g., hacked). In addition, in the event the system identifies an emergency while the UAV is in flight, the UAV can execute one or more emergency actions, such as executing an emergency flight plan to land at a safe landing zone at the site of operation and/or deploying a parachute to float to the ground.

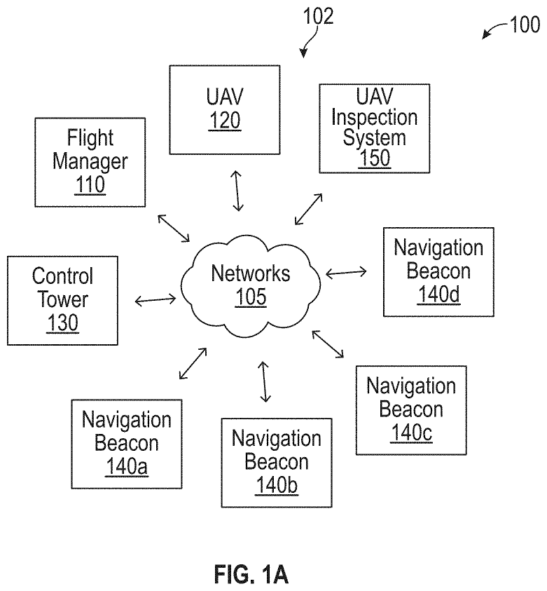

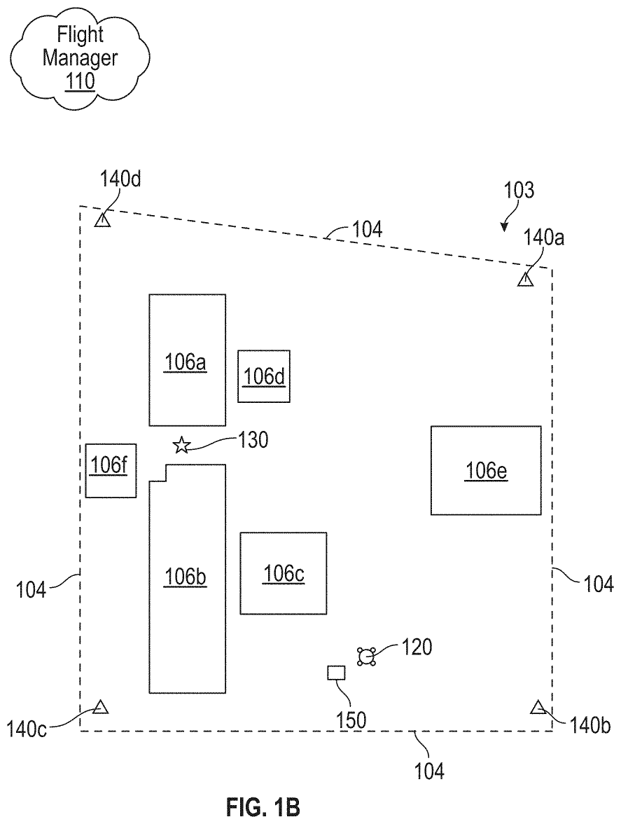

Specific details of several embodiments of the present technology are described herein with reference to FIGS. 1-12. Although many of the embodiments of UAVs with multiple processors discussed herein are described in relation to commercial settings (e.g., to capture aerial photographs, collect data, and/or perform other commercial-related tasks), other applications and other embodiments in addition to those described herein are within the scope of the present technology. For example, unless otherwise specified or made clear from context, the systems, devices, and methods of the present technology can be used in nearly any context in which a UAV is employed. As specific examples, the systems, devices, and methods of the present technology can be employed in civil settings (e.g., to inspect roads or bridges, to track or help fight wildfires, and/or to perform other public service tasks) or in recreational activities. The systems, devices, and methods of the present technology may also be applicable in combat or surveillance operations. Furthermore, although many of the embodiments discussed herein are described in relation to UAVs having multiple controllers and/or processors, other applications and other embodiments in addition to those described herein are within the scope of the present technology. For example, unless otherwise specified or made clear from context, the secure parameter procedures described herein can be employed in the context of a UAV having a single processor or wherever a secure bounded controller is used. Such applications are within the scope of the present technology.

It should be noted that other embodiments in addition to those disclosed herein are within the scope of the present technology. Further, embodiments of the present technology can have different configurations, components, and/or procedures than those shown or described herein. Moreover, a person of ordinary skill in the art will understand that embodiments of the present technology can have configurations, components, and/or procedures in addition to those shown or described herein and that these and other embodiments can be without several of the configurations, components, and/or procedures shown or described herein without deviating from the present technology.

### B. Selected Embodiments of UAVs, Including Multi-Processor UAVs with Secured Parameters, and Associated Systems, Devices, and Methods

1. Multi-Processor UAVs and Associated UAV Operational Containment Systems

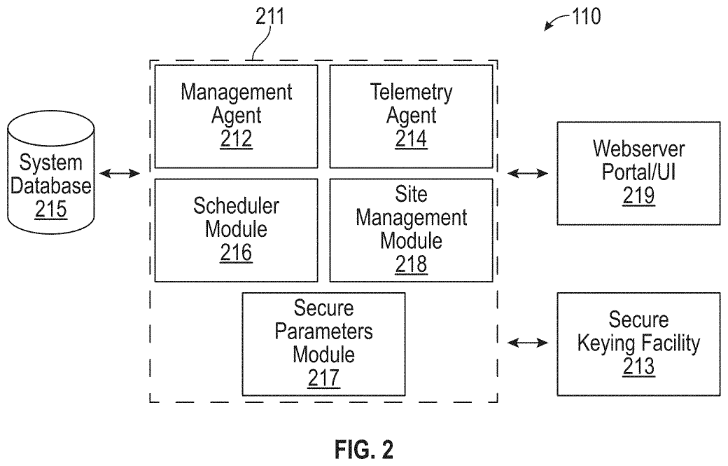

FIG. 1A is a partially schematic representation (a) of a UAV operation containment system 100 (“the system 100”) and (b) of an environment 102 in which the system 100 operates. FIG. 1B is a partially schematic diagram of a site of operation 103 at which the system 100 of FIG. 1A can be employed. In the embodiment illustrated in FIG. 1A, the system 100 includes a flight manager 110; a UAV 120; a control tower 130; navigation beacons 140 (identified individually as navigation beacons 140a-140d); and a UAV inspection system 150. The flight manager 110, the UAV 120, the control tower 130, the navigation beacons 140, and the UAV inspection system 150 are individually discussed in greater detail below with reference to FIGS. 2-6, respectively. In some embodiments, the system 100 can include additional or fewer components than are shown in FIG. 1A. For example, the system 100 can include more than one UAV 120, more than one control tower 130, a greater or lesser number (e.g., zero, one, two, three, or more than four) navigation beacons 140, and/or a greater or lesser number (e.g., zero or more than one) UAV inspection systems 150. In some embodiments, the system 100 does not include the UAV 120 and/or the UAV 120 is merely in communication with the system 100.

Referring to FIG. 1B, the site of operation 103 (which is viewed from above) includes property boundary lines 104 and various obstacles 106 (e.g., buildings 106a-106d, parking lots 106e, and other infrastructure 106f). The UAV 120, the control tower 130, the navigation beacons 140, and the UAV inspection system 150 are physically deployed at the site of operation 103 at various positions within the property boundary lines 104. In contrast, the flight manager 110 is a collection of cloud-based hardware and software components operating outside the site of operation 103. The cloud-based flight manager eliminates costs and complexities of setting up and maintaining the flight manager at the site of operation, including heavy investments in hardware needed to operate the flight manager, transferring the hardware to each site of operation (which are often rural), and/or setting up and maintaining the flight manager on site. Furthermore, an onsite flight manager is typically limited in processing power to the hardware onsite. In contrast, a cloud-based flight manager can be easily scaled to provide any level of processing power required for a sight of operation. In addition, having a cloud-based flight manager can be advantageous to provide access to the system from anywhere there is an Internet connection. Moreover, a cloud-based flight manager permits clients operating multiple sites of operation to use the same interface to control the system at any one of the sites of operation merely by logging into their account and specifying the site of operation in the flight manager.

In the illustrated embodiment, the control tower 130 is centrally located within the site of operation 103 to provide connectivity between (a) the UAV 120, the navigation beacons 140a-140d, and/or the UAV inspection system 150 and (b) the flight manager 110 over a wide area network (WAN), such as a broadband network and/or the Internet. Furthermore, the navigation beacons 140a-140d are deployed at corners and/or along the perimeter of the site of operation 103 to provide, in combination with the control tower 130, a continuous local area network (LAN) (e.g., a mesh network) over the site of operation 103. The positions of the control tower 130 and/or of the navigation beacons 140a-140d, however, can vary from the positions illustrated in FIG. 1B and/or can be based at least in part on characteristics (e.g., geometry and/or topography) of a site of operation.

Referring again to FIG. 1A, the components of the system 100 are connected to and communicate through one or more networks 105 of the environment 102. Networks 105 may be any type of public or private, wired or wireless, network connection suitable for transporting data between nodes. In some embodiments, the Internet is one of the networks 105 used to provide connectivity, but other networks (e.g., LANs, metropolitan area networks (MANs), or other WANs) may additionally or alternatively be used. For example, the components of the system 100 can be connected through dedicated landlines or through a terrestrial or satellite wireless network.

The networks 105 may include various network topologies, such as mesh networking or star/tree networking. The networks 105 can employ various communication protocols. For example, the networks 105 can employ various wireless communication protocols, including WiFi, Zigbee, Z-Wave, Bluetooth, Bluetooth LE, or another wireless network protocol (e.g., cellular network protocols, such as 3G, 4G, or 5G). Additionally, or alternatively, the networks can employ various Internet protocols (e.g., Transmission Control Protocol/Internet Protocol (TCP/IP)) and/or various messaging protocols (e.g., MQ Telemetry Transport (MQTT) or hypertext transfer protocol (HTTP)). In these and other embodiments, the networks 105 can employ the Micro Air Vehicle Link (MAVlink) protocol for certain communications involving the UAV 120.

As a specific example, the control tower 130 communicates with the flight manager 110 over the networks 105 using a secure communication channel (e.g., a virtual private network (VPN)) established over a WAN, such as a broadband network and the Internet. Additionally, the networks 105 include a LAN (e.g., a wireless mesh network) formed by the control tower 130 and the navigation beacons 140a-140d. The LAN is used to place the UAV 120, the navigation beacons 140a-140d, and/or the UAV inspection system 150 in communication with (a) the control tower 130 and/or (b) the flight manager 110 over the WAN (e.g., via the control tower 130 and/or only via the control tower 130). In one embodiment, the control tower 130 communicates with the navigation beacons 140a-140d over the LAN using the Zigbee communication protocol. Furthermore, the UAV 120 can communicate with the control tower 130 and/or with the navigation beacons 140a-140d using a communication protocol in which the round trip time (RTT) of packets of information can be calculated. As discussed in greater detail below, RTTs of information packets can be used to calculate the position of the UAV 120 in space.

In some embodiments, the networks 105 can provide communication redundancy. For example, various components of the system 100 can include both (a) global positioning systems (GPS) that use, for example, global navigation satellite systems (GNSS) and (b) a wireless LAN that facilitates trilateration calculations. This provides the components of the system 100 two methodologies of determining their positions in space, thereby improving accuracy and reliability of the system 100. Various components of the system 100 can additionally, or alternatively, include “n” number of radios or communication devices to create “n” level redundancy for communication and/or localization.

For the sake of clarity and explanation, the LAN formed by the control tower 130 and the navigation beacons 140 is referred to hereinafter as a mesh network. Additionally, the WAN that facilitates communication between the flight manager 110 and the control tower 130 (and/or other components of the system 100) deployed at the site of operation 103 is referred to hereinafter as a broadband network and/or the Internet. A person of ordinary skill in the art, however, will readily recognize that the LAN in other embodiments of the present technology can include one or more other network configurations in addition to or in lieu of mesh network, and/or that the WAN in other embodiments of the present technology can include one or more other network configurations in addition to or in lieu of a broadband network and/or the Internet.

FIG. 2 is a block diagram of the UAV flight manager 110 of the system 100 illustrated in FIGS. 1A and 1B. In some embodiments, the flight manager 110 is a collection of cloud-based hardware and software components that serve as the overall orchestrator of the system 100. For example, the flight manager 110 handles (a) UAV flight planning, operational envelope definition, and device provisioning, as well as (b) system deployment and flight data management.

As shown in FIG. 2, the flight manager 110 includes various agents or modules 211. These include a management agent 212, a secure keying facility 213, a telemetry agent 214, a scheduler module 216, a secure parameters module 217, and a site management module 218. The management agent 212 communicates with the UAV 120 (FIGS. 1A and 1B) and with the navigation beacons 140a-140d (FIGS. 1A and 1B) of the system 100 via direct communication with the control tower 130 (FIGS. 1A and 1B). For example, the management agent 212 receives weather, air traffic data (e.g., automatic dependent surveillance-broadcast (ADS-B) data, radar data, and/or other data (such as acoustic data and/or light detection and ranging (LIDAR) data) indicative of aircraft or objects in flight), positional information, and/or other data from the control tower 130 and/or the navigation beacons 140. In some embodiments, the management agent 212 employs one or more servers that use the MQTT messaging protocol to manage the UAV 120, the control tower 130, and the navigation beacons 140a-140d, for example, as an Internet of Things (IoT) device network.

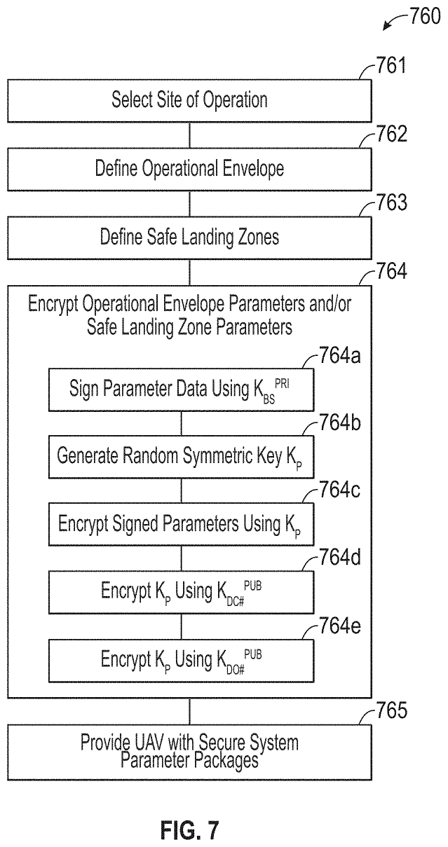

The telemetry agent 214 communicates with the UAV 120 over the mesh network formed via the control tower 130 and the navigation beacons 140a-140d. In some embodiments, the telemetry agent 214 uses the MavLink communication protocol to provide real-time communication and control of the UAV 120 during active flight operations. The scheduler module 216 controls all aspects of scheduled activities, such as scheduled UAV flight plans and supporting functions. The secure parameters module 217 handles securing (e.g., digitally signing and/or encrypting) various system parameters, such as operational envelope parameters that can be provided to the UAV 120. For example, the secure parameters module 217 can interface with the secure keying facility 213 to digitally sign and/or encrypt system parameters. The secure keying facility 213 can be a facility that stores public and/or private keys of various public key infrastructure (PKI) credentials. In some embodiments, the secure keying facility 213 is established and/or maintained in accordance with the WebTrust certification for certification authorities. The secure parameters module 217 and the secure keying facility 213 are discussed in greater detail below with respect to FIGS. 7-10. The site management module 218 manages all aspects of an individual site deployment, such as deployment of system components, air traffic management, user management, and site conditions as they relate to UAV flight.

In some embodiments, various agents and modules of the flight manager 110 are distributed over multiple physical devices, and/or the functionality implemented by the agents and modules may be provided by calls to remote servers. Moreover, multiple servers may be used to implement various functions of the flight manager 110 described herein. In these and other embodiment, the agents and modules of the flight manager 110 can be co-located (e.g., on a single server or on a group of servers in close proximity to one another). The software to support the functionality of the flight manager 110 may be stored on one or more computer-readable media, such as an optical drive, flash memory, hard drive, or other storage device, or combination of such storage devices.

In the illustrated embodiment, the flight manager 110 further includes a system database 215 and a webserver portal and/or user interface 219 (“the webserver portal 219”). The database 215 stores various data of the system 100, including data regarding deployment sites, users, companies, and the like. For example, the flight manager 110 receives positional information, environmental condition data, and/or video/image data from the control tower 130, the navigation beacons 140, and/or the UAV 120 of the system 100. All or a subset of this information can be stored, for example, in the system database 215. Additionally, or alternatively, the flight manager 110 can use all or a subset of this information as inputs for identifying site conditions (e.g., emergencies) and/or for making various flight-related decisions (e.g., appropriate responses to identified emergencies) for the UAV 120. In some embodiments, the database 215 is a MySQL database. The database 215 can be local or remote, and/or can be distributed in one or more physical devices.

The webserver portal 219 of the flight manager 110 provides a user interface (e.g., via an application interface) that extends a user control over specific aspects of the system 100. For example, the webserver portal 219 can present a user a site of operation as a map interface that permits the user (a) to deploy various components of the system 100, (b) check the statuses of various components of the system 100, (c) communicate directly with individual components of the system 100, and/or (d) to define UAV flight operational envelope parameters, such as property boundaries, no fly zones, altitude restricted areas, and/or safe landing zones. A user may also, via the webserver portal 219, (i) define, schedule, and/or trigger UAV flights, and/or (iii) manually control a UAV in active flight.

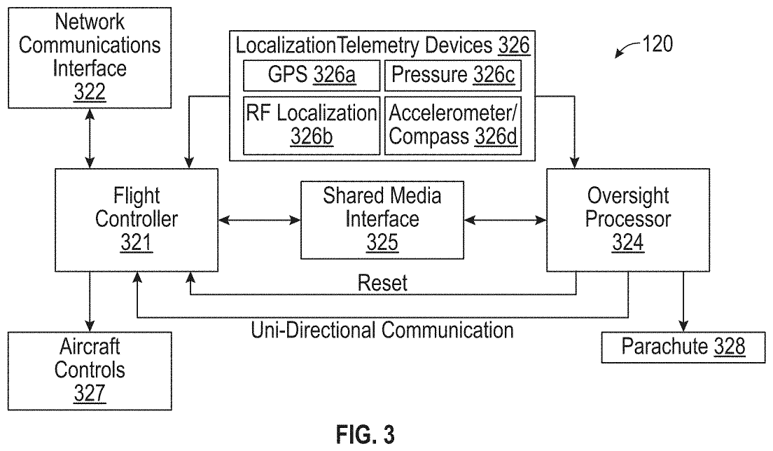

FIG. 3 is a block diagram of the UAV 120 of the system 100 (FIGS. 1A and 1B). As shown, the UAV 120 has a multi-processor architecture (in this case, a dual-processor architecture) comprising an onboard flight controller 321 and an onboard oversight processor 324. The UAV 120 further includes a shared media interface 325, localization telemetry devices 326, aircraft control mechanisms 327, a (e.g., WAN and/or LAN) network communications interface 322, and a parachute 328. In some embodiments, the shared media interface 325 is a memory interface (e.g., a non-volatile memory interface) configured to receive system parameters from memory media. The memory media can be non-volatile memory, such as onboard flash memory, a removable secure digital (SD) card or smart card, and/or another memory medium configured to persistently store the system parameters, such as operational envelope parameters that define an operational envelope for the UAV 120 and/or safe landing zone parameters that identify the locations of safe landing zones for the UAV. Examples of operational envelope parameters that can be received from memory via the shared media interface 325 include locations of (a) site, property, and/or perimeter boundaries, (b) no-fly zones, and/or (c) altitude restricted areas.

The system parameters received via the shared media interface 325 are provided to both the flight controller 321 and the oversight processor 324. As discussed in greater detail below, the system parameters can be secured (e.g., digitally signed and/or encrypted). In some embodiments, the flight controller 321 and/or the oversight processor 324 of the UAV 120 can be provided with unique device credentials (e.g., private keys of device credential PKI keypairs) that can be used to decrypt the parameters. For example, as discussed in greater detail below, system parameters can be encrypted using a payload key and a public key of a device credential PKI keypair. The public key can correspond to a private key of the device credential PKI keypair. The private key can be stored on the flight controller 321 (e.g., when the flight controller 321 and/or the UAV 120 is manufactured). The private key enables the flight controller 321 to decrypt the system parameters encrypted with the corresponding public key. In this manner, system parameters can be encrypted such that only a specific UAV and/or only a specific controller or processor of that UAV can decrypt the system parameters. This can increase the likelihood that the UAV 120 is provided with correct system parameters for the UAV 120, as well as system parameters that have not been tampered with or corrupted.

The localization telemetry devices 326 can include a variety of sensors, such as a GPS 326a, a radiofrequency (RF) localization system 326b, a pressure sensor 326c, and/or an accelerometer and/or compass 326d. The GPS 326a and the RF localization system 326b are used to determine the position of the UAV 120 in two-dimensional and/or three-dimensional space. For example, the RF localization system 326b can include an RF radio (e.g., a 900 MHz radio) configured to communicate with one or more control towers 130 (e.g., the control tower 130 of FIGS. 1A and 1B) and/or multiple (e.g., two or more) navigation beacons 140 (e.g., two or more of the navigation beacons 140a-140d of FIGS. 1A and 1B). As described in greater detail below, the RF localization system 326b can use a communications protocol (e.g., Zigbee, Bluetooth, and/or another suitable protocol) that enables the RF localization system 326b to capture the RTT of packets of information sent to and received from the navigation beacons 140 and/or the control tower(s) 130. Because the position of each control tower 130 and navigation beacon 140 of the system 100 is known, the RTTs of packets sent to three or more components of the system 100 at any given time can be used to determine (via trilateration) the position of the UAV 120 in two-dimensional and/or three-dimensional space at that given time. The GPS 326a and the RF localization system 326b can be independently used to determine the UAV's 120 position, so the GPS 326a and the RF localization system 326b provide the UAV 120 localization redundancy.

The pressure sensor 326c can independently be used to determine the UAV's 120 altitude. For example, the UAV 120 can calibrate the pressure sensor 326c using, for example, a barometric pressure reading captured at ground level at or near the site of operation 103 (e.g., a pressure reading captured by a pressure sensor on the control tower 130 and/or on a navigation beacon 140, a pressure reading broadcasted by a nearby airfield in Meteorological Aerodrome Reports (METARs), and/or a pressure reading captured by the pressure sensor 326c of the UAV 120 while the UAV 120 is positioned on or near the ground, such as when the UAV 120 is grounded at the UAV inspection system 150). An altitude of the UAV 120 can then be calculated from barometric pressure readings taken by the pressure sensor 326c, for example, while the UAV 120 is in flight. Thus, the pressure sensor 326c can be used as a redundancy to the UAV's altitude determined using the GPS 326a and/or the RF localization system 326b.

As shown in FIG. 3, data captured by the GPS 326a, the RF localization system 326b, the pressure sensor 326c, and/or the accelerometer and/or compass 326d is supplied to both the flight controller 321 and the oversight processor 324. If additional redundancy is desired, separate localization radios can be provided on the UAV 120 for each of the flight controller 321 and the oversight processor 324. For example, the UAV 120 in other embodiments can include two GPSs 326a (one for the flight controller 321 and one for the oversight processor 324) and/or two RF localization systems 326b (one for the flight controller 321 and one for the oversight processor 324). In some embodiments, additional localization radios are provided on the UAV to safely land the UAV in the event one or more of the localization radios fails, malfunctions, or is otherwise compromised (e.g., is hacked).

The flight controller 321 can function as the main controller or processor of the UAV 120 and primarily control actual flight and operation of the UAV 120, limited to the operational envelope defined by system parameters received over the shared media interface 325. In particular, the flight controller 321 can receive a flight plan from the flight manager 110 over the network communications interface 322. The flight plan can define a flight path within the operational envelope. Using (a) localization information received from the localization telemetry devices 326 and (b) the aircraft control mechanisms 327, the flight controller 321 can (e.g., autonomously or at the direction of the flight manager 110 and/or of a user) navigate the UAV 120 along the flight path, thereby executing the flight plan. During flight, the flight controller 321 responds to any commands it receives from the flight manager 110 over the network communications interface 322. These commands can include, for example, emergency instructions for maneuvering the UAV 120 in response to changes in flight conditions (e.g., in response to a possible collision event between the UAV 120 and another object, in response to a change in weather conditions, and/or in response to another change posing a risk to the UAV) and/or instructions for navigating the UAV 120 in accordance with manual control of the UAV 120 provided to a user via the webserver portal 219 (FIG. 2) of the flight manager 110. In some embodiments, the flight controller 321 references the operational envelope as a geofence for the UAV 120 and prevents operation of the UAV 120 outside of the operational envelope. For example, when the UAV 120 is manually controlled by a user and the UAV 120 encounters a boundary of the operational envelope, the flight controller 321 can stop the UAV 120 and cause the UAV 120 to hover in place until the flight controller 321 receives a navigational command from the user and/or the flight manager 110 that will not cause the UAV 120 to breach the operational envelope.

The oversight processor 324 separately oversees the behavior of the flight controller 321, enhancing safe operation of the UAV 120 within the operational envelope. In one example, the oversight processor 324 continually monitors the UAV's 120 position in space and compares the position to operational envelope parameters. When the flight controller 321 safely operates the UAV 120 within the operational envelope defined by the parameters, the oversight processor 324 passively monitors the information it receives from the localization telemetry devices 326 and takes no action. On the other hand, in the event that the oversight processor 324 determines that the flight controller 321 is operating at, near, or beyond the operational envelope defined by the parameters, the oversight processor 324 can communicate with the flight controller 321 over a uni-directional communications line to trigger an alert or alarm, reduce operational velocity of the UAV 120, force execution of alternate instructions (e.g., to hover in place, to immediately return the UAV 120 to within the operational envelope and/or to the flight path, to land the UAV 120 within a safe landing zone, to return the UAV 120 to its original take off location, and/or to perform another action to attempt to bring the UAV back into a safe operating state), to execute a gradual shutdown procedure, and/or to temporarily or permanently disable the UAV 120. Additionally, or alternatively, the oversight processor 324 can employ a flight termination system in the event the flight controller 321 is operating at, near, or beyond the UAV's operational envelope. For example, the oversight processor can assert a reset signal over a uni-directional reset communications line to temporarily or permanently cease functionality of the flight controller 321, and/or the oversight processor can deploy the parachute 328 of the UAV 120 (allowing the UAV 120 to safely drop to the ground).

In some embodiments, the oversight processor 324 does not control actual flight and operations of the UAV 120, leaving this control to the flight controller 321. In these embodiments, the oversight processor 324 merely oversees operation of the flight controller 321 and intercedes when it detects a violation of system parameters (e.g., of operational envelope parameters associated with the UAV 120), which can indicate that the flight controller 321 has failed, is malfunctioning, and/or has become compromised (e.g., hacked). Additionally, or alternatively, the oversight processor 324 is largely (e.g., completely or nearly completely) offline, meaning that the oversight processor does not receive instructions from the flight manager 110 or other components of the system 100. This can decrease the likelihood that the oversight processor 324 becomes compromised (e.g., hacked).

In some embodiments, the flight controller 321 and/or the oversight processor 324 continuously monitor the UAV's position and altitude in space by comparing (a) the UAV's position determined using the GPS 326a of the localization telemetry devices 326 to (b) the position determined using the RF localization system 326b of the localization telemetry devices 326. Additionally, or alternatively, the flight controller 321 and/or the oversight processor 324 can perform a similar comparison of the altitude of the UAV 120 determined using the GPS 326a and/or the RF localization system 326b to an altitude of the UAV 120 determined using the pressure sensor 326c of the localization telemetry devices 326. In the event the determined positions and/or the determined altitudes vary by greater than a threshold amount, the flight controller 321 and/or the oversight processor 324 can instruct the UAV 120 to hover in place, land within a safe landing zone, or take another precautionary action until the determined positions and/or the determined altitudes stabilize and come back into alignment. Failure to stabilize or come back into alignment can indicate a hardware malfunction or a potential localization hack. The UAV 120 can take similar action in response to other in-flight emergencies, such as loss of communication with the control tower(s) 130 or the navigation beacons 140, or loss of sensor or air traffic data in the area of the UAV 120. In this manner, the multi-processor architecture of the UAV 120 increases the likelihood that a UAV 120 is brought back to a safe operating state in the event of failure, malfunction, or other compromise (e.g., hack) of the flight controller 321, of one or more localization telemetry devices 326, other components of the UAV 120, and/or other components of the system 100.

In some embodiments, the UAV 120 includes a body or housing, one or more propellers, and a camera configured to capture in-flight video or still images. In these and other embodiments, the body or housing of the UAV 120 can store or enclose the parachute 328. In these and still other embodiments, the UAV 120 can include other equipment (e.g., in addition to or in lieu of a camera). The body/housing, number and/or orientation of propellers, and/or other equipment included in the UAV 120 can be tailored to a specific task for which a UAV 120 is employed. For example, a UAV 120 employed for logistics operations (e.g., delivering packages) can include a body/housing, a number of selectively oriented propellers, and/or a gripping mechanism in addition to or in lieu of a camera such that the UAV 120 is suitable to perform the logistics operations.

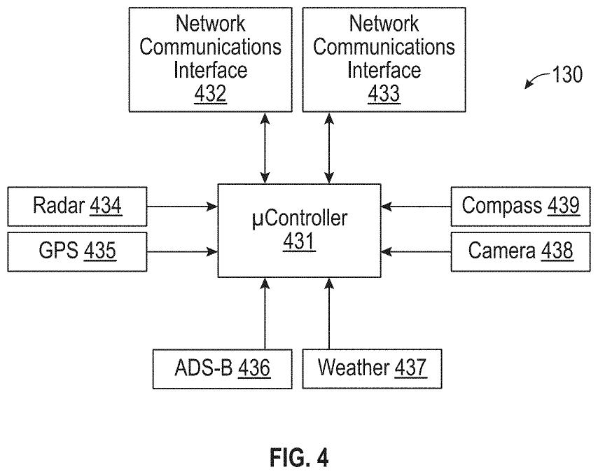

FIG. 4 is a block diagram of the control tower 130 of the system 100 (FIGS. 1A and 1B). As shown, the control tower 130 includes a microcontroller 431 that serves as a bridge between two network communications interfaces 432 and 433. In some embodiments, the network communications interface 432 is a WAN communications interface (e.g., a broadband network radio) configured to facilitate communications between the flight manager 110 (FIGS. 1 and 2) and the control tower 130 over, for example, a secure communications channel, such as a VPN. In these and other embodiments, the network communications interface 433 is a LAN communications interface (e.g., a mesh network radio) configured to facilitate communication between (a) the control tower 130, (b) the navigation beacons 140 (FIGS. 1A and 1B), (c) the UAV 120 (FIGS. 1 and 3), and/or (d) the UAV inspection system 150 (FIGS. 1A and 1B). Thus, the control tower 130 serves as the primary communications gateway between (a) the flight manager 110 and (b) the various components of the system 100 deployed at a site of operation. In this manner, the control tower 130 (i) forms a LAN (e.g., a mesh communications network) with the navigation beacons 140 and (ii) provides WAN (e.g., broadband and/or Internet) connectivity to all components of the system 100 deployed at the site of operation so as to enable communication between the flight manager 110 in the cloud and a UAV 120 deployed at the site of operation.

In some embodiments, the control tower 130 can include various sensors and systems to collect environmental condition data related to the site of operation. For example, in the illustrated embodiment, the control tower 130 includes a radar system 434, a GPS 435, an ADS-B radio 436, weather sensors 437, a camera 438, and a compass 439. The compass 439 can provide the orientation of the control tower 130. The GPS 435 can determine positional information of the control tower 130 using, for example, GNSS. In some embodiments, the control tower 130 can serve as an real-time kinematic (RTK) GNSS base station for the system 100 and can relay correction parameters to the GPS radios included in other components of the system 100 (e.g., in the navigation beacons 140 and/or in the UAV 120), thereby providing centimeter-level (or greater) accuracy in the data reported over the network communications interface 433 to the control tower 130 from the GPS radios of the system 100. As discussed in greater detail below, determining the position of the control tower 130 can facilitate determining the position of the UAV 120 in flight.

The ADS-B radio 436 provides the microcontroller 431 real-time site air traffic information. The weather sensors 437 can include, for example, a temperature sensor, a pressure sensor, a wind sensor, and/or one or more other sensors configured to collect data pertinent to atmospheric flight conditions for the UAV 120. The camera 438 is configured to capture video or still images of all or a subset of the site of operation (e.g., all or a portion of the operational envelope of the UAV 120 proximate the control tower 130). The video or images captured by the camera 438 can be (i) processed by the control tower 130 and/or by the flight manager 110 and (ii) used to identify (a) the UAV 120 and/or (b) objects (e.g., foreign objects) within the operational envelope that present a risk of colliding or otherwise interfering with the UAV 120. Similarly, the radar system 434 can include one or more radar antennae and can be configured to identify (a) the UAV 120 and/or (b) objects (e.g., foreign objects) within the operational envelope that present a risk of colliding with the UAV 120.

Furthermore, although not shown in FIG. 4, the control tower 130 in other embodiments of the present technology can include one or more other sensors and systems in addition to or in lieu of one or more of the sensors and system illustrated in FIG. 4. For example, the control tower 130 can include (i) an acoustic sensor or system that can identify and/or determine positional information related to aircraft or other objects by sound and/or (ii) a light LIDAR sensor or system that can identify and/or determine positional information related to the aircraft or other objects using light. In these and other embodiments, the control tower 130 can lack one or more of the sensors and systems illustrated in FIG. 4. For example, the control tower 130 can lack the radar system 434 in some embodiments.

The microcontroller 431 of the control tower 130 is also configured to receive, over the network communications interface 433, (a) environmental condition data related to the site of operation from one or more (e.g., all or a subset) of the navigation beacons 140, (b) data (e.g., positional, directional, altitude, pressure, and/or other data) from the UAV 120, and/or (c) UAV health and/or battery status information from the UAV inspection system 150. Environmental condition data received from the navigation beacons 140 can include, for example, (a) positional information captured by a GPS, (b) weather data captured by one or more weather sensors, and/or (c) video/image data captured by a camera of a corresponding navigation beacon 140. In some embodiments, the video or images captured by navigation beacon(s) 140 can be (i) processed by the control tower 130 and/or by the flight manager 110 and (ii) used to identify (a) the UAV 120 and/or (b) objects (e.g., foreign objects) within the operational envelope that present a risk of colliding with the UAV 120.

In some embodiments, the control tower 130 continuously collects environmental condition data using the GPS 435, the ADS-B radio 436, the weather sensors 437, the camera 438, and/or the radar system 434. In these and other embodiments, the control tower continuously receives environmental condition data from one or more navigation beacons 140 and/or from the UAV 120. In other embodiments, the control tower 130 periodically collects environmental condition data and/or the control tower 130 periodically receives environmental condition data from one or more of the navigation beacons 140 and/or the UAV 120. For example, the control tower 130 may be idle or passive until it is instructed by the flight manager 110 to enable various sensors or services of the control tower 130, of one or more beacons 140, of the UAV 120, and/or of the UAV inspection system 150.

Similarly, the control tower 130 can continuously or periodically (e.g., in response to instructions received from the flight manager 110) stream environmental condition data to the flight manager 110. The flight manager 110 can receive the environmental condition data from the control tower 130 as inputs for making various flight-related decisions (e.g., emergency decisions) for the UAV 120. All or a subset of the environmental condition data received by the flight manager 110 can be stored, for example, in the system database 215 (FIG. 2).

The control tower 130 is deployed at a site of operation 103 (FIG. 1B). In some embodiments, electronics of the control tower 130 can be positioned approximately six to twelve meters above the ground or other obstacles to facilitate data collection and/or sufficient communication integrity between the control tower 130, the navigation beacons 140, the UAV 120, and/or the UAV inspection system 150. In some embodiments, the control tower 130 is battery-operated. In these and other embodiments, the control tower 130 includes one or more solar panels to charge the battery. Additionally, or alternatively, the control tower 130 can include a power cord configured to connect the control tower 130 to a power supply.

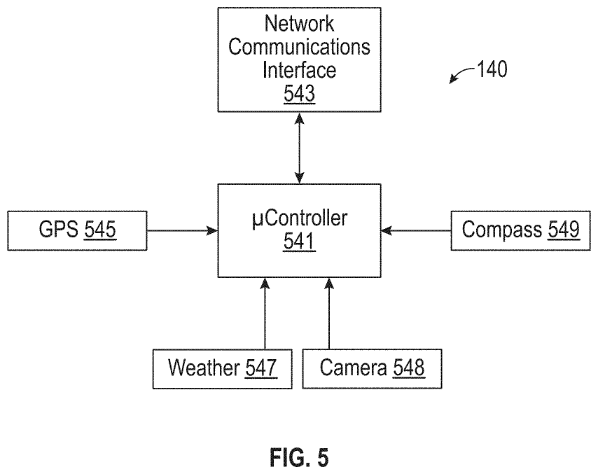

FIG. 5 is a block diagram of a navigation beacon 140 (e.g., one of the navigation beacons 140a-140d) of the system 100 (FIGS. 1A and 1B). As shown, the navigation beacon 140 includes a microcontroller 541 that interfaces with a network communications interface 543, a GPS 545, weather sensors 547, a camera 548, and a compass 549. In some embodiments, the network communications interface 543 is a LAN communications interface (e.g., a mesh network radio). In these embodiments, the navigation beacon 140 is configured to create a LAN (e.g., a mesh communications network) in conjunction with other navigation beacons 140 and the control tower 130 of the system 100, thereby facilitating communication between (a) the navigation beacon 140, the control tower 130 (FIGS. 1A, 1B, and 4), the UAV 120 (FIGS. 1A, 1B, and 3), and/or the UAV inspection system 150 (FIGS. 1A and 1B), and/or (b) any of these components and the flight manager 110 (via the control tower 130).

Although the navigation beacon 140 is illustrated as including only the network communications interface 543 in FIG. 5, a navigation beacon 140 configured in accordance with various embodiments of the present technology can include one or more other network communications interfaces in addition to or in lieu of the network communications interface 543. For example, a navigation beacon 140 in some embodiments can include a WAN communications interface (e.g., a broadband network radio) in addition to or in lieu of the network communications interface 543. This can enable the navigation beacon 140 to use the WAN communications interface to interface directly with the flight manager 110 (e.g., over the Internet) rather than requiring the navigation beacon 140 to interface with the flight manager 110 via the control tower 130.

The compass 549 can provide the orientation of the navigation beacon 140, and the GPS 545 can be used to determine positional information of the navigation beacon 140 using, for example, GNSS. The position of the navigation beacon can be transmitted to the control tower 130, to the flight manager 110, and/or to the UAV 120. As discuss in greater detail below, the known position of the navigation beacon 140 can be used as a point of reference for the UAV 120 to determine its location in space (e.g., using the UAV's 120 RF localization system). For example, the UAV 120 can calculate the RTT of a packet sent between the UAV 120 and the navigation beacon 140. Using the calculated RTT of the packet and the known location of the navigation beacon 140, the UAV 120 can calculate a distance between the UAV 120 and that navigation beacon 140. The UAV 120 is able to determine its position in space via trilateration using this distance in combination with two other distances calculated from (a) the RTTs of two other packets sent to one or more other navigation beacons 140 and/or the control tower 130, and (b) the known positions of the one or more navigation beacons 140 and/or the control tower 130, respectively. Thus, the navigation beacon 140 serves as a navigation aid to the UAV 120 to supplement the UAV's 120 onboard GPS unit. For this reason, navigation beacons 140 and the control tower 130 of the system 100 are positioned at a site of operation 103 (FIG. 1B) such that the UAV 120 can communicate with a number (e.g., one, two, three, or more) of navigation beacons 140 and/or control tower(s) 130 of the system 100 at any given time to enable the UAV 120 to accurately identify its position in space.

The weather sensors 547 of the navigation beacon 140 can include, for example, a temperature sensor, a pressure sensor, a wind sensor, and/or one or more other sensors configured to collect data pertinent to atmospheric flight conditions for the UAV 120. Data collected by one or more of the weather sensors 547 can be transmitted (e.g., streamed) to the control tower 130 and/or to the flight manager 110 in real-time, at set intervals, and/or in response to a command from the flight manager 110 and/or the control tower 130.

The camera 548 of the navigation beacon 140 is configured to capture video or still images of all or a subset of the site of operation (e.g., all or a portion of the operational envelope of the UAV 120 proximate the navigation beacon 140). Video or images captured by the camera 548 can be transmitted (e.g., streamed) to the control tower 130 and/or the flight manager 110 in real-time, at set intervals, and/or in response to a command received from the flight manager 110 and/or the control tower 130. The video or images captured by the camera 548 can be (i) processed by the control tower 130 and/or by the flight manager 110, and (iii) used to identify (a) the UAV 120 and/or (b) objects (e.g., foreign objects) within the operational envelope that present a risk of colliding or otherwise interfering with the UAV 120.

Furthermore, although not shown in FIG. 5, the navigation beacon 140 in other embodiments of the present technology can include one or more other sensors and systems in addition to or in lieu of one or more of the sensors and systems illustrated in FIG. 5. For example, the navigation beacon 140 can include (i) an acoustic sensor or system that can identify and/or determine positional information related to aircraft or other objects by sound and/or (ii) a LIDAR sensor or system that can identify and/or determine positional information related to the aircraft or other objects using light. In these and other embodiments, the navigation beacon 140 can lack one or more of the sensors and/or systems illustrated in FIG. 5. For example, the navigation beacon 140 can lack all or a subset of the weather sensors 547 in some embodiments.

In some embodiments, the navigation beacon 140 continuously determines its location, collects weather data, and/or captures video/image data. In other embodiments, the navigation beacon 140 periodically determines its position, collects weather data, and/or captures video/image data. For example, the navigation beacon 140 may be idle or passive until it is instructed by the flight manager 110 or the control tower 130 to determine its positional information, to collect weather data, to capture video/image data, and/or to communicate with the UAV 120. The navigation beacon 140 can capture video/image data for the entire duration of the UAV's 120 flight or for only a portion of the UAV's 120 flight (e.g., for only the portion of the UAV's 120 flight when the UAV 120 is within a threshold distance from the navigation beacon 140).

Similarly, the navigation beacon 140 can continuously or periodically (e.g., in response to instructions received from the flight manager 110 and/or the control tower 130) transmit (e.g., stream) its positional information, weather data, and/or video/image data to the control tower 130 and/or to the flight manager 110. In the event the system 100 includes more than one control tower 130, instructions received by the navigation beacon 140 that direct the navigation beacon 140 to transmit data to a control tower 130 can specify to which control tower 130 of the system 100 the data is to be sent. The flight manager 110 can use the positional information, the weather data, and/or the video/image data for making various flight-related decisions (e.g., emergency decisions) for the UAV 120.

The navigation beacon 140 is deployed at a site of operation 103 (FIG. 1B). In some embodiments, electronics of the navigation beacon 140 can be positioned approximately two to three meters above the ground or other obstacles to facilitate data collection and/or sufficient communication integrity between the navigation beacons 140, the control tower 130, the UAV 120, and/or the UAV inspection system 150. In some embodiments, the navigation beacon 140 is battery-operated. In these and other embodiments, the navigation beacon 140 includes one or more solar panels to charge the battery. Additionally, or alternatively, the navigation beacon 140 includes a power cord configured to connect the navigation beacon 140 to a power supply.

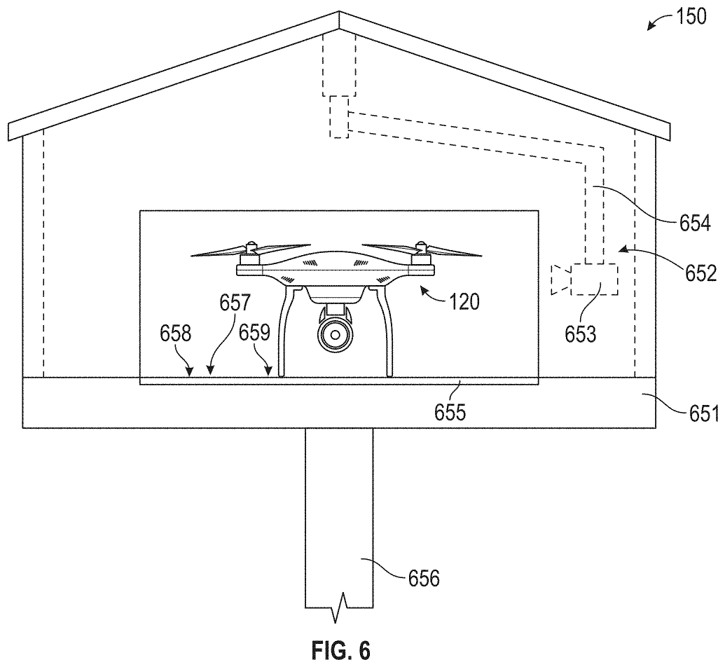

FIG. 6 is a partially schematic representation of a UAV inspection system 150 of the system 100 (FIGS. 1A and 1B). The UAV inspection system 150 includes an enclosure 651 that houses a visual scanning system 652 and a docking station 657. As shown, the enclosure 651 is also configured to house a UAV 120 (e.g., when the UAV 120 is positioned on the docking station 657). In some embodiments, the enclosure 651 protects or shelters the UAV 120 from environmental conditions at a site of operation 103 when the UAV 120 is not in flight. The enclosure 651 can be positioned on a pole or mount 656. This can facilitate positioning the enclosure off the ground and/or at various locations with different terrain topographies (e.g., flat or not flat) and/or other features (e.g., wet or swampy ground). Alternatively, the enclosure 651 can be positioned on the ground or on another surface (e.g., the roof of a building).

The visual scanning system 652 can include a camera 653 attached to or positioned on a mount or arm 654. In some embodiments, the visual scanning system 652 can include other components in addition to or in lieu of the camera 653 and/or the arm 654. For example, the visual scanning system 652 can include more than one camera 653 and/or more than one arm 654. In these and other embodiments, the visual scanning system 652 can include one or more light sources (not shown) configured to illuminate at least a portion of the UAV 120 when the UAV 120 is positioned on the docking station 657 and/or within the enclosure 651.

The arm 654 of the visual scanning system 652 in the illustrated embodiment is rotatable about the UAV 120 and/or the docking station 657. In these and other embodiments, the arm 654 can have a number of (e.g., one, two, three, four, five, and/or six) degrees of freedom to position the camera 653 at various locations and/or orientations about (e.g., the interior of) the enclosure 651. In other embodiments, such as in embodiments having multiple cameras 653, the arm 654 can be fixed and/or have a limited range of motion. As discussed in greater detail below, the camera 653 is configured to capture video and/or images of the UAV 120 at various positions about the UAV 120 that can be used to assess the health of the UAV 120.

The docking station 657 of the UAV inspection system 150 includes a landing pad 658 and a wireless (e.g., induction) charging pad 659. In some embodiments, the landing pad 658 is extendable from within an interior of the enclosure 651 to an exterior of the enclosure 651. For example, the enclosure 651 can include a flap or door 655 that can open allowing the landing pad 658 to extend outside of the enclosure (e.g., to facilitate the UAV 120 taking off from and/or landing on the landing pad 658). Additionally, or alternatively, the landing pad 658 can be retractable from the exterior of the enclosure 651 to within the interior of the enclosure 651 (e.g., to position the UAV 120 within the enclosure 651 and/or proximate the visual scanning system 652). In other embodiments, the landing pad 658 is stationary, and the UAV 120 can be (e.g., autonomously) maneuvered to position the UAV 120 on the landing pad 658 and within the enclosure 651. The door 655 of the enclosure 651 can close when the landing pad 658 and/or the UAV 120 are within the interior of the enclosure 651. Alternatively, the enclosure 651 can lack a door 655 in some embodiments.

In operation, the UAV inspection system 150 is configured to (e.g., autonomously) inspect the UAV 120 (e.g., pre-flight) using the visual scanning system 652 to assess aircraft integrity. For example, the UAV inspection system 150 can use the visual scanning system 652 to capture one or more baseline videos and/or images of the UAV 120 (e.g., when the UAV inspection system 150 and/or the UAV 120 is first deployed at the site of operation). In these and other embodiments, the UAV inspection system 150 can use the visual scanning system 652 to capture one or more subsequent videos and/or images of the UAV 120 (e.g., prior to the UAV 120 executing a flight plan). The UAV inspection system 150 and/or the flight manager 110 can compare the subsequent video and/or images to the baseline video and/or images to assess the health of the UAV 120 and/or to identify potential damage to the UAV 120.

The landing pad 658 of the docking station 657 provides the UAV 120 a location to land and await a flight plan from the flight manager 110. The wireless charging pad 659 of the docking station 657 can wirelessly charge one or more of the UAV's 120 onboard batteries for a future flight when the UAV 120 is positioned on or over the landing pad 658. In other embodiments, the UAV inspection system 150 and/or the docking station 657 can include other equipment for recharging the UAV's 120 onboard batteries in addition to or on in lieu of the wireless charging pad 659. For example, in some embodiments, the landing pad 658 can include one or more contact pads that are put in electrical communication with the UAV's 120 onboard batteries when the UAV 120 is physically positioned on the landing pad 658.

In some embodiments, the UAV inspection system 150 includes one or more network communications interfaces (not shown). For example, the UAV inspection system 150 can include a LAN communications interface (e.g., a mesh network radio) and/or a WAN communications interface (e.g., a broadband network radio). The LAN communications interface can enable the UAV inspection system 150 to communicate with the UAV 120, the control tower 130, the navigation beacons 140, and/or the flight manager 110 (e.g., via the control tower 130). The WAN communications interface can enable the UAV inspection system 150 to communicate directly with the flight manager 110. In this manner, the UAV inspection system 150 can report battery and/or health status data related to the UAV 120 to the control tower 130 and/or to the flight manager 110. As part of the battery and/or health status data, the UAV inspection system 150 can provide the control tower 130 and/or the flight manager 110 an indication of whether the UAV 120 is flightworthy to execute a flight plan.

In some embodiments, the UAV inspection system 150 can include one or more components in addition to or in lieu of one or more components illustrated in FIG. 6. For example, the UAV inspection system 150 can include another type of inspection system, such as a non-visual inspection system in addition to or in lieu of the visual scanning system 652. In these and other embodiments, the UAV inspection system 150 can include one or more additional docking stations 657 and/or visual inspection systems 652 such that the enclosure 651 can house (and the UAV inspection system 150 can inspect) more than one UAV 120.

As discussed above, the control tower 130, the navigation beacons 140a-140d, and the UAV inspection system 150 can be used to generate and/or capture various data (e.g., positional data, environmental conditions data, video/image data, and/or UAV battery and/or health data). All or a portion of this data can be relayed to the control tower 130 and/or to the flight manager 110. In these and other embodiments, the control tower 130 and/or the flight manager 110 can process the data to, for example, identify potential in-flight emergencies or risks to the UAV 120. In response to an identified risk or emergency, the flight manager 110 can instruct the UAV 120 to execute various emergency actions (e.g., evasive actions). A more detailed explanation of this process is provided in U.S. patent application Ser. No. 17/179,970.

2. Associated Methods

FIG. 7 is a flow diagram illustrating a method 760 of defining and securing (e.g., digitally signing and/or encrypting) system parameters (e.g., operational envelope parameters and/or safe landing zone parameters) for a multi-processor UAV, in accordance with various embodiments of the present technology. All or a subset of the steps of the method 760 can be executed by various components or devices of a UAV operational containment system, such as the system 100 illustrated in FIGS. 1A and 1B or other suitable systems. For example, all or a subset of the steps of the method 760 can be executed by components or devices of the flight manager 110 (FIGS. 1A, 1B, and 2), such as the secure keying facility 213, the telemetry agent 214, the system database 215, the secure parameters module 217, the site management module 218, and/or the webserver portal 219. Additionally, or alternatively, all or a subset of the steps of the method 760 can be executed by a UAV (e.g., the UAV 120 of FIGS. 1A, 1B, and 3), and/or by a user (e.g., an operator, a service technician, and/or a field technician) of the system 100 and/or the UAV. Furthermore, any one or more of the steps of the method 760 can be executed in accordance with the discussion above.

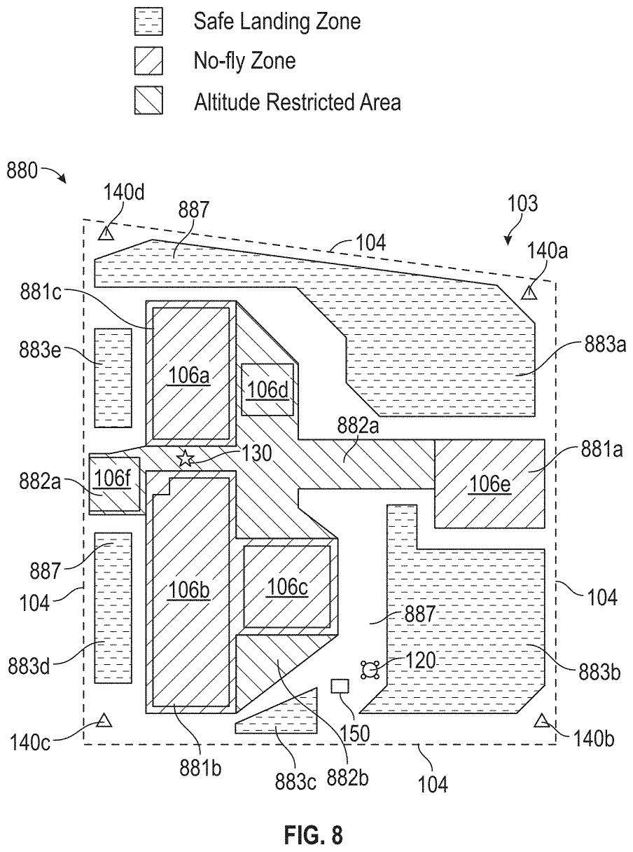

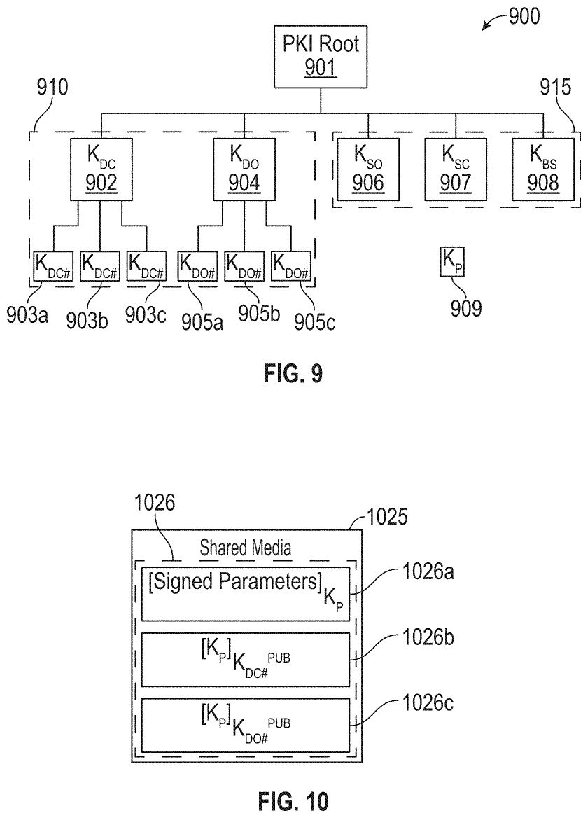

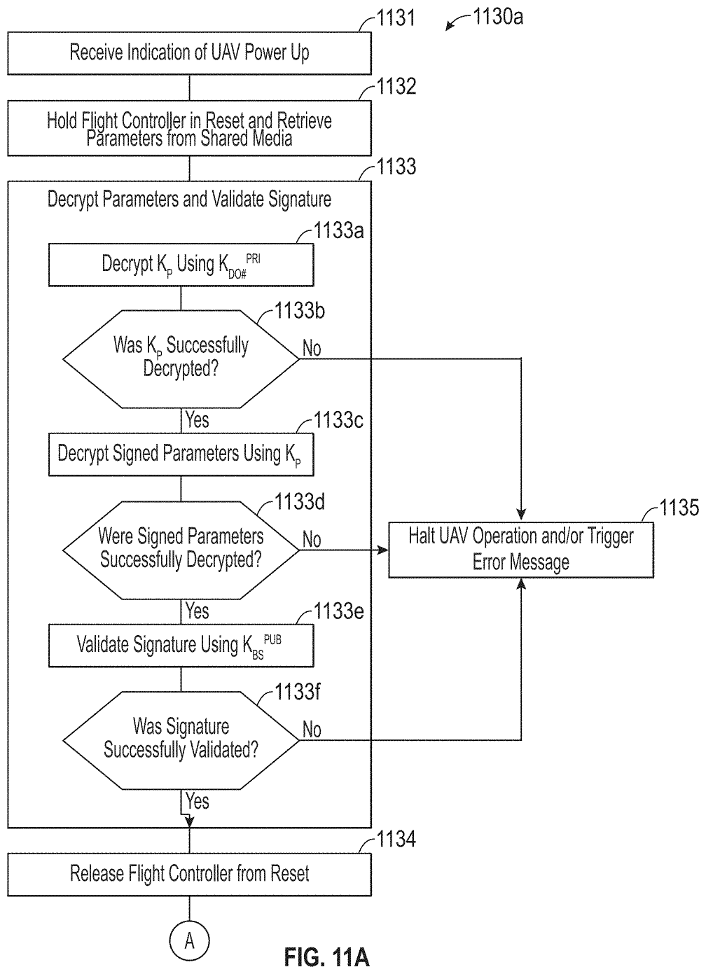

For the sake of clarity and explanation, the method 760 is discussed in part below with occasional reference to FIGS. 8-10. FIG. 8 is a partially schematic diagram of a user interface 880 illustrating the example site of operation 103 of FIG. 1B. As discussed in greater detail below, a user can utilize the user interface 880 to define an operational envelope and/or safe landing zones for a UAV 120 at the site of operation 103. FIG. 9 is a block diagram of a public key infrastructure (PKI) management architecture 900 and of a payload key K_{P} 909 configured in accordance with various embodiments of the present technology. As discussed in greater detail below, the PKI management architecture 900 and the payload key K_{P} 909 can be used to secure (e.g., digitally sign and/or encrypt), decrypt, and/or validate system parameters (e.g., operational envelope parameters). FIG. 10 is a partially schematic representation of shared memory media 1025 storing a secure system parameters package 1026 in accordance with various embodiments of the present technology. As discussed in greater detail below, the shared memory media 1025 (a) can be non-volatile memory that is readily removable from a UAV and/or that is (e.g., permanently) resident onboard the UAV and/or (b) can be used to provide system parameters (e.g., operational envelope parameters, safe landing zone parameters, firmware, flight plans, and/or other parameters) to the UAV.

Referring to FIG. 7, the method 760 begins at block 761 by selecting a site of operation at which a UAV is or will be deployed. A user can select a site of operation using a user interface presented to the user via, for example, a webserver portal (e.g., the webserver portal 219 of FIG. 2) of a flight manager of the system. In response, the user interface can present the user a map (e.g., a street map, a topographical map, a two-dimensional or three-dimensional map, a satellite image, and/or another suitable map) of the selected site of operation. Referring to FIG. 8 as an example, when the user selects the site of operation 103 illustrated in FIG. 1B, the system 100 can present the user a satellite image of the site of operation 103 within the user interface 880. Buildings 106a-106d, a parking lot 106e, and other infrastructure 106f within the site of operation 103 can be visible within this satellite image. Streets, walkways, and other features (e.g., trees, terrain topology, terrain geometry, and/or other features) of the site of operation may also be visible in the map presented to the user. In some embodiments, property boundaries lines 104 for the site of operation 103 can be automatically populated (e.g., using data retrieved from property records) in the map. In other embodiments, the user can define the property boundaries at block 762.

At block 762, the method 760 continues by defining an operational envelope for the UAV. The operational envelope is the air space within the site of operation in which the UAV is permitted to fly. By default, the operational envelope can be defined as a three-dimensional polygon or shape limited by the property boundaries of the site of operation and an altitude of approximately 122 meters (or another altitude set by a regulating body and/or representing a maximum UAV altitude operating limit). As discussed above, the property boundaries of the site of operation can be automatically populated within a map of the site of operation when the user selects the site of operation at block 761. Alternatively, the user can identify or set the property boundaries for the site of operation at block 762. In either case, the user can edit the property boundaries and/or the altitude operating limits for the site of operation presented in the user interface. For example, a user can edit the legal property boundaries of the site of operation inward to avoid known obstructions about the perimeter of the site of operation and/or to create a buffering no-fly zone along all or a subset of the perimeter of the site of operation.

In some embodiments, the user may edit the operational envelope based at least in part on known site constraints, such as infrastructure or other features (e.g., trees, terrain topology, terrain geometry, and/or other features). This may include defining no-fly zones and/or altitude restricted areas. A no-fly zone is a zone identified within the site of operation that stretches from the ground (or lower) to the highest altitude operating limit for the UAV. As such, a UAV is prohibited from flying over or under no-fly zones and must instead fly around them. By contrast, an altitude restricted area is a zone identified within the site of operation that is limited to one or more specific ranges of altitudes. As such, a UAV is permitted to fly over and/or under an altitude restricted area at altitudes outside of the specified range(s) that define the altitude restricted area, and to fly around the altitude restricted area.

Referring to FIG. 8, for example, the user may define no-fly zones 881 (identified individually as no-fly zones 881a-881c in FIG. 8) around critical infrastructure (e.g., buildings 106a-106c and parking lot 106e), areas in which humans are known to commonly congregate, and/or other areas. Thus, a UAV deployed at the site of operation 103 is prohibited from flying over the buildings 106a-106c and the parking lot 106e at any altitude. Additionally, or alternatively, the user may define altitude restricted areas 882 (identified individually as altitude restricted areas 882a and 882b in FIG. 8) over or around infrastructure (e.g., over non-critical building 106d and other infrastructure 106f, around or between portions of buildings 106a-106d, and/or over or around other infrastructure, such as a crane temporarily set up at the site of operation) or other features (e.g., trees, walkways, and/or other features). Here, the altitude restricted areas 882a and 882b are limited to altitudes ranging from an altitude corresponding to the ground (or lower) and maximum altitudes set by the user. Thus, a UAV deployed at the site of operation 103 is permitted to fly over the altitude restricted areas 882a and 882b and over building 106d and other infrastructure 106f, but only at altitudes above the maximum altitudes set by the user.

In some embodiments, all editing of the property boundaries, no-fly zones, and/or altitude restricted areas is performed via additive and subtractive polygons or shapes in the user interface. For example, a user can draw or otherwise define/identify (a) perimeter boundaries, (b) maximum and/or minimum permitted altitude operating limits, (c) no-fly zones, and/or (d) altitude restricted areas in the user interface. Additionally, or alternatively, the user can specify start and stop altitudes for the perimeter boundaries, no-fly zones, and/or altitude restricted areas such that the perimeter boundaries, no-fly zones, and/or altitude restricted areas are defined as three-dimensional polygons or shapes that limit the operational envelope for a UAV. Thus, the operational envelope for a UAV can be limited to be within the perimeter boundaries (e.g., to be within the property boundaries and/or other user-defined boundaries) of the site of operation and outside of the no-fly zones and altitude restricted areas. Furthermore, a user can remove perimeter boundaries, no-fly zones, and/or altitude restricted areas (e.g., in the event that temporary infrastructure, such as a crane, has been removed from the site of operation) by removing the corresponding polygon or shape in the user interface, thereby expanding the operational envelope of the UAV to include the corresponding section of airspace at the site of operation.

As discussed in greater detail below with respect to block 764 of the method 760, operational envelope parameters defined at block 762 of the method 760 can correspond to a specific UAV at the site of operation. For example, a user can define a first operational envelope for a first UAV that is or will be deployed at the site of operation and a second operational envelope for a second UAV that is or will be deployed at the site of operation. The first and second operational envelopes can be the same or can differ. As another example, a user can define an operational envelope for a first region at the site of operation, and the operational envelope for the first region can be associated with a UAV that is or will be deployed at the site of operation to execute flight plans within the first region. Continuing with this example, the user can additionally or alternatively define an operational envelope for a second region (e.g., a region different and/or separate from the first region) at the site of operation, and the operational envelope for the second region can be associated with another UAV that is or will be deployed at the site of operation to execute flight plans within the second region.

At block 763, the method 760 continues by defining safe landing zones for a UAV within the operational envelope defined at block 762. A safe landing zone is an area in which the UAV can land or attempt to land in the event of an in-flight emergency (e.g., to avoid critical infrastructure, humans, and/or vehicles). A user may identify and/or define safe landing zones in the user interface (e.g., by drawing, outlining, or otherwise marking the safe landing zones on the map of the site of operation). Any safe flat area with no obstructions or human traffic is encouraged (and may be recommended via the user interface) as a safe landing zone to provide as much coverage as possible for any potential flight paths of the UAV. For example, the flight manager can (i) evaluate the operational envelope defined at block 762 to identify grass, concrete, and/or other areas clear of buildings, vehicles, and/or other obstructions, and (ii) generate and display polygons or shapes over these areas in the user interface to present a user with suggested safe landing zones within the operational envelope. The user can then alter, delete, and/or confirm the polygons or shapes as safe landing zones.

Referring to FIG. 8 again as an example, a user has defined five safe landing zones 883 (identified individually as safe landing zones 883a-883e in FIG. 8) on the user interface within the operational envelope defined at the site of operation 103. As shown, the safe landing zones 833a-883e collectively cover a large portion of a floor of the operational envelope. This can increase the chances of a UAV successfully landing within one of the safe landing zones 833a-833e in the event of an in-flight emergency, regardless of the UAV's position along a flight path extending anywhere within the operational envelope. At this point, the operational envelope for a UAV deployed at the site of operation and the safe landing zones within the operational envelope are defined.

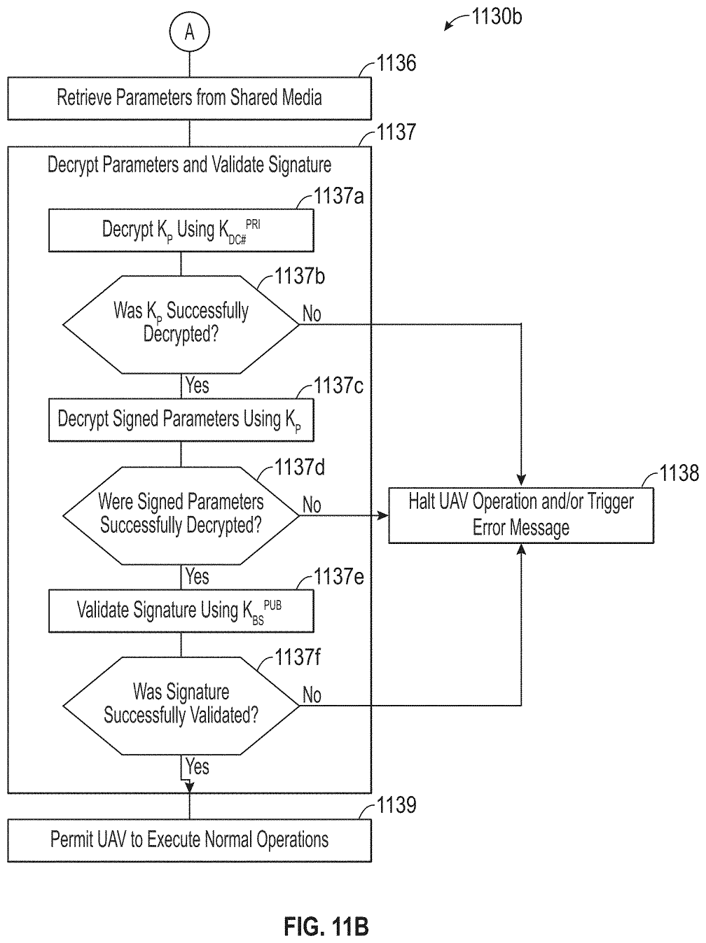

At block 764, the method 760 continues by securing (e.g., digitally signing and/or encrypting) system parameters, such as the operational envelope parameters and/or the safe landing zone parameters defined at blocks 762 and/or 763, respectively. In some embodiments, securing system parameters at block 764 includes digitally signing and/or encrypting system parameters such that a same data payload including the system parameters (i) can be delivered to and/or shared between each of two or more controllers or processors, yet (ii) can be verified and/or reserved for use by only specific ones of the two or more controllers or processors. For example, a PKI management architecture and/or a payload key (described in greater detail below) can be used to secure system parameters for a flight controller and an oversight processor of a UAV (and/or for any other device having two or more controllers/processors and in which one controller/processor executes operations bounded by the system parameters and another controller/processor monitors adherence of the one controller/processor to the system parameters). As described in greater detail below, the PKI management architecture and/or the payload key facilitate digitally signing the system parameters to ensure that the system parameters do not become corrupted and/or are not tampered with before verification by the flight controller and the oversight processor. Additionally, the PKI management architecture and/or the payload key can encrypt the system parameters such that only a specific flight controller and/or only a specific oversight processor can decrypt the system parameters and/or verify the digital signature. Thus, the PKI management architecture and/or the payload key can increase the likelihood that the flight controller and the oversight processor operate with valid system parameters that are intended for those controllers or processor. Furthermore, because the same system parameters file is provided to both the flight controller and the oversight processor (as discussed in greater detail below with respect to FIGS. 11A and 11B), the flight controller and the oversight processor can operate from the same source of truth. In other words, the oversight processor can compare flight operations of the flight controller to the same system parameters that the flight controller uses to conduct the flight operations.

FIG. 9 is a block diagram of an example PKI management architecture 900 and of a payload key K_{P} 909 that can be used at block 764 of the method 760 and that is configured in accordance with various embodiments of the present technology. For the sake of clarity and explanation, an overview of the PKI management architecture 900 and the payload key K_{P} 909 is provided below before describing how the PKI management architecture 900 and the payload key K_{P} 909 are used at block 764 of the method 760 (FIG. 7) to secure system parameters. The description below assumes Rivest, Shamir, Adelman (RSA) encryption is used for all asymmetric encryption operations. In other embodiments of the present technology, any other asymmetric encryption algorithm applicable to digital signatures and PKI architectures can be used. Furthermore, the description below assumes Advanced Encryption Standard (AES) encryption (with or without an initialization vector) is used for all symmetric encryption operations. In other embodiments of the present technology, any other symmetric encryption algorithm can be used.

As shown in FIG. 9, the PKI management architecture 900 can include (a) several public/private keypairs 901-908. The public/private keypairs 901-908 include a PKI root keypair (PKI Root) 901, a flight controller credential root keypair (K_{DC}) 902, an oversight processor credential root keypair (K_{DO}) 904, oversight processor code signing credentials (K_{SO}) 906, flight controller code signing credentials (K_{SC}) 907, and bounds signing credentials (K_{BS}) 908. K_{DC} 902 and K_{DO} 904 are device authentication credentials 910. K_{SO} 906, K_{SC} 907, and the K_{BS} 908 are data integrity signing credentials 915.

PKI Root 901 is a PKI public/private keypair (PKI Root^{PUB} and PKI Root^{PRI}) that can serve as a core root of trust for the PKI architecture. The private key PKI Root^{PRI} (a) can be stored within a secure keying facility (e.g., within the secure keying facility 213 of FIG. 2), and (b) can be used to sign K_{DC} 902, K_{DO} 904, K_{SO} 906, K_{SC} 907, and K_{BS} 908.

K_{DC} 902 is a PKI public/private keypair (K_{DC}^{PUB} and K_{DC}^{PRI}) that can serve as an intermediate root for generating unique flight controller device credentials (K_{DC#}) 903 (identified individually as K_{DC#} 903a, K_{DC#} 903b, and K_{DC#} 903c in FIG. 9). The private key K_{DC}^{PRI} (a) can be stored in a secure keying facility (e.g., within the secure keying facility 213 of FIG. 2), and (b) can be used for device credential generation. The public key K_{DC}^{PUB} (a) can be delivered to a flight controller of a UAV in firmware provided to the flight controller, and (b) can be used for key signature validation. For example, a signing algorithm can generate a first cryptographic hash of data for a flight controller of a UAV and encrypt the first cryptographic hash with the private key K_{DC}^{PRI} to generate a digital signature. When the data and the signature are provided to the flight controller, the flight controller can decrypt the digital signature using the public key K_{DC}^{PUB} to extract the first cryptographic hash, generate a second cryptographic hash of the data, and compare the first cryptographic hash to the second cryptographic hash. The flight controller can determine that the digital signature is valid when the first cryptographic hash matches the second cryptographic hash, indicating that the data delivered to the flight controller is valid.

K_{DC#} 903 (e.g., K_{DC#} 903a-903c) are PKI public/private keypairs (K_{DC#}^{PUB} and K_{DC#}^{PRI}) that can serve as device credentials or identifiers for specific flight controllers (e.g., the flight controller 321 of the UAV 120 of FIG. 3). The private keys K_{DC#}^{PRI} can be securely provided to flight controllers of UAVs during manufacture of the flight controllers and/or the UAVs. The public keys K_{DC#}^{PUB} can be stored within a system database (e.g., the system database 215 of the flight manager 110 of FIG. 2) and can be used to generate secure system parameters packages (as described in greater detail below).

K_{DO} 904 is a PKI public/private keypair (K_{DO}^{PUB} and K_{DO}^{PRI}) that can serve as an intermediate root for generating unique oversight processor device credentials (K_{DO#}) 905 (identified individually as K_{DO#} 905a, K_{DO#} 905b, and K_{DO#} 905c in FIG. 9). The private key K_{DO}^{PRI} (a) can be stored in a secure keying facility (e.g., in the secure keying facility 213 of FIG. 2), and (b) can used for device credential generation. The public key K_{DO}^{PUB} (a) can be delivered to an oversight processor of a UAV in firmware provided to the oversight processor, and (b) can be used for key signature validation. For example, the private key K_{DO}^{PRI} and the public key K_{DO}^{PUB} can be used to deliver data to an oversight processor of a UAV in a manner generally similar to how the private key K_{DO}^{PRI} and the public key K_{DC}^{PUB} of K_{DC} 902 are used to deliver data to a flight controller of a UAV.

K_{DO#} 905 (e.g., K_{DO#}905a-905c) are PKI public/private keypairs (K_{DO#}^{PUB} and K_{DO#}^{PRI}) that can serve as device credentials or identifiers for specific oversight processors (e.g., the oversight processor 324 of the UAV 120 of FIG. 3). The private keys K_{DO#}^{PRI} can be securely provided to oversight processors of UAVs during manufacture of the oversight processors and/or the UAVs. The public keys K_{DO#}^{PUB} can be stored within a system database (e.g., the system database 215 of the flight manager 110 of FIG. 2) and can be used to generate secure system parameters packages (as described in greater detail below).

K_{BS} 908 is a PKI public/private keypair (K_{BS}^{PUB} and K_{BS}^{PRI}) that can be used for signing and validating system parameters, such as operational envelope parameters. The private key K_{BS}^{PRI} can be stored in a secured keying facility (e.g., within the secure keying facility 213 of FIG. 2) and can be used for signing system parameters. The public key K_{BS}^{PUB} (a) can be delivered to a flight controller and an oversight processor of a UAV in firmware provided to the flight controller and the oversight processor, and (b) can be utilized by both the flight controller and the oversight processor to validate integrity of system parameters provided to the UAV (as discussed in greater detail below).

K_{SO} 906 and K_{SC} 907 are PKI public/private keypairs (K_{SO}^{PUB} and K_{SO}^{PRI}, and K_{SC}^{PUB} and K_{SC}^{PRI}, respectively) that can be used for signing and validating firmware provided to oversight processors and flight controllers, respectively, of UAVs.

The payload key K_{P} 909 can be a randomly generated symmetric key that can be used to encrypt (e.g., using AES encryption) system parameters and/or digital signatures, such as operational envelope parameters (as described in greater detail below). In some embodiments, payload key K_{P} 909 can be generated by a random number generator (e.g., of the flight manager 110 and/or the secure parameters module 217).

In some embodiments, the PKI management architecture 900 can include additional and/or alternative PKI public/private keypairs and/or keys than illustrated in FIG. 9. For example, PKI management architectures 900 in other embodiments of the present technology can include a greater or less number (e.g., one or more than two) device authentication credentials for systems and/or devices of the present technology that include a greater or less number (e.g., one or more than two) of controllers, processors, or other devices requiring credential authentication. Additionally, or alternatively, PKI management architectures 900 in other embodiments of the present technology can include one or more other data integrity signing credentials in addition to or in lieu of K_{SO} 906, K_{SC} 907, and/or K_{BS} 908, such as credentials for signing safe landing zone parameters, flight plan parameters, and/or other system parameters. Alternatively, K_{SO} 906, K_{SC} 907, and/or K_{BS} 908 can be used to digitally sign safe landing zone parameters, flight plan parameters, and/or other system parameters.

Referring to FIG. 9 and block 764 of the method 760 of FIG. 7 together, a UAV operational containment system (e.g., the secure keying facility 213 and/or the secure parameters module 217 of the flight manager 110 of the system 100 of FIGS. 1A-2) can secure system parameters, such as the parameters defined at blocks 761-763 and/or other system parameters, using various keys of the PKI management architecture 900 and the payload key K_{P} 909 of FIG. 9. For example, using the private key K_{BS}^{PRI} of K_{BS} 908, the system can (at subblock 764a) digitally sign operational envelope parameters defined at block 762 of the method 760. The digital signature can be included with (e.g., appended to or otherwise associated with) the operational envelope parameters for later verification (as discussed in greater detail below with respect to FIGS. 11A and 11B). Continuing with this example, the system can (at subblocks 764b and 764c, respectively) randomly generate the payload key (i.e., K_{P} 909) and can use the payload key K_{P} 909 to encrypt the digitally signed operational envelope parameters from subblock 764a.

At subblock 764d, the system can retrieve a public key K_{DC#}^{PUB} from a system database (e.g., the system database 215 of the flight manager 110 of FIG. 2) and can use it to encrypt a first copy of the payload key K_{P} 909. The public key K_{DC#}^{PUB} retrieved and used at subblock 764d can be a public key of a K_{DC#} 903 (e.g., K_{DC#} 903a) corresponding to a specific flight controller (e.g., on a specific UAV). In this manner, the system can encrypt the first copy of K_{P} 909 in such a manner that only the specific flight controller (e.g., a flight controller provided with a private key K_{DC#}^{PRI} corresponding to the public key K_{DC#}^{PUB} of the K_{DC#} 903 used by the system at subblock 764d) can decrypt this copy of K_{P} 909. This can increase the likelihood that system parameters (e.g., operational envelope parameters) are used by only a flight controller for which the system parameters are intended.

Similarly, at subblock 764e, the system can retrieve a public key K_{DO#}^{PUB} from a system database (e.g., the system database 215 of the flight manager 110 of FIG. 2) and can use it to encrypt a second copy of the payload key K_{P} 909. The public key K_{DO#}^{PUB} retrieved and used at subblock 764e can be a public key of a K_{DO#} 905 (e.g., K_{DO#} 905a) corresponding to a specific oversight processor (e.g., on a specific UAV). In this manner, the system can encrypt the second copy of K_{P} 909 in such a manner that only the specific oversight processor (e.g., an oversight processor provided with a private key K_{DO#}^{PRI} corresponding to the public key K_{DO#}^{PUB} of the K_{DO} 905 used by the system at subblock 764e) can decrypt this copy of K_{P} 909. This can increase the likelihood that system parameters (e.g., operational envelope parameters) are used by only an oversight processor for which the system parameters are intended.

Three encrypted system parameters files can therefore be generated at block 764 of the method 760: (i) an encrypted secured system parameters file that includes system parameters (e.g., operation envelope parameters) that are digitally signed by a known certificate authority, (ii) an encrypted file of a first copy of the payload key K_{P} 909 that was used to encrypt the secured system parameters file, and (iii) an encrypted file of a second copy of the payload key K_{P} 909 that was used to encrypt the secured system parameters file. (As discussed above, the encrypted file of the first copy of K_{P} 909 can be encrypted in such a way that only an intended flight controller can decrypt the file. Similarly, the encrypted file of the second copy of K_{P} 909 can be encrypted in such a way that only an intended oversight processor can decrypt the file.) A set of the three encrypted system parameters files are hereinafter referred to as a secure system parameters package. Furthermore, a secure system parameters package including operational envelope parameters is referred to hereinafter as a secure operational envelope parameters package. This nomenclature can be extended to other secure system parameters packages including other system parameters. For example, a secure system parameters package that includes safe landing zone parameters, firmware, and/or flight plans can be referred to as a secure safe landing zone parameters package, a secure firmware package, and/or a second flight plan package, respectively.

For the sake of clarity and explanation, securing system parameters is primarily discussed in detail above with respect to securing operational envelope parameters. The procedures discussed above, however, can additionally or alternatively be used to secure other system parameters (e.g., safe landing zone parameters, firmware, and/or flight plans). Furthermore, in some embodiments, safe landing zone parameters are considered examples of operational envelope parameters such that secure operational envelope parameters provided to a UAV can include both the operational envelope parameters defined at block 762 and the safe landing zone parameters defined at block 763. In other embodiments, the secure operational envelope parameters provided to a UAV can exclude safe landing zone parameters, and/or secure safe landing zone parameters can be provided to a UAV separately from (e.g., in separate secure system parameters packages from) the secure operational envelope parameters.

At block 765, the method 760 continues by providing a UAV with one or more secure system parameters packages, such as a secure operational envelope parameters package discussed above with respect to block 764. The UAV can be a UAV that comprises the intended flight controller and/or the intended oversight processor discussed above with respect to subblocks 764d and 764e. In these and other embodiments, the UAV can be a UAV that corresponds to the system parameters in the secure system parameters package(s). For example, as discussed above with respect to block 762, operational envelope parameters in a secure operational envelope parameters package can define an operational envelope for a specific region of a site of operation. Continuing with this example, the UAV can be a UAV that is or will be deployed at the site of operation (e.g., within the operational envelope) to execute flight plans within the specific region of the site of operation.

In some embodiments, providing the UAV with the secure system parameters package(s) includes saving the secure system parameters package(s) to non-volatile memory. The secure system parameters package(s) can be saved to non-volatile memory at a time files of the secure system parameters packages(s) are generated (e.g., at a time files are generated at block 764 of the method 760) and/or at a later time. The non-volatile memory can be non-volatile memory (e.g., permanently) resident onboard the UAV, such as onboard flash memory. In these embodiments, the secure system parameters package(s) can be provided to a UAV by remotely saving the secure system parameters package(s) to non-volatile memory resident onboard a UAV (e.g., over one or more of the networks 105 of FIG. 1 and/or using various components of a UAV operational containment system, such as a flight manager and/or a UAV inspection system).

Additionally, or alternatively, the non-volatile memory can be included on a memory device that can be removably provided to a UAV. For example, the non-volatile memory can be included on a Secure Digital (SD) card, a CompactFlash card, a SmartMedia card, a memory stick, a MultiMediaCard, a Universal Serial Bus card, and/or another removable memory device and/or card. In these embodiments, secure system parameters package(s) can be provided to a UAV by (i) saving the secure system parameters package(s) to non-volatile memory initially separate from the UAV (e.g., using a computing device in communication with various components of a UAV operational containment system, such as a flight manager, a secure parameters module of the flight manager, and/or a UAV inspection system), and (ii) physically providing the UAV with the non-volatile memory (e.g., by inserting a memory device including the non-volatile memory into the UAV).

In these and other embodiments, the non-volatile memory is memory media that can be shared between multiple processors of a UAV. For example, FIG. 10 is a partially schematic representation of a shared memory media 1025 in accordance with various embodiments of the present technology. The shared memory media 1025 can be non-volatile memory resident onboard the UAV or non-volatile memory of a memory device that is configured to be removably provided to a UAV. As its name suggests, the shared memory media 1025 can be shared between a flight controller (e.g., flight controller 321 of FIG. 3) and an oversight processor (e.g., oversight processor 324 of FIG. 3) of a UAV. For example, the shared memory media 1025 can be operably connected to a flight controller and an oversight processor via a shared media interface (e.g., shared media interface 325 of FIG. 3) such that both the flight controller and the oversight processor can access secure system parameters packages stored on the shared memory media 1025.

In the embodiment illustrated in FIG. 10, the shared memory media 1025 includes a secure system parameters package 1026. The secure system parameters package 1026 includes a secured system parameters file 1026a that is encrypted with a payload key K_{P} 909 (FIG. 9) of subblocks 764c-764e. In this embodiment, the secured system parameters file 1026a includes system parameters (e.g., operational envelope parameters) that are digitally signed with a known certificate authority (e.g., a private key K_{BS}^{PRI} of K_{BS} 908). The secure system parameters package 1026 further includes two files 1026b and 1026c that include copies of the payload key K_{P} 909. One copy is encrypted for a flight controller of a UAV using a public key K_{DC#}^{PUB} of a device credential K_{DC#} 903 (e.g., K_{DC#} 903a of FIG. 9), and the other copy is encrypted for an oversight processor of the UAV using a public key K_{DO#}^{PUB} of a device credential K_{DO#}905 (e.g., K_{DO#}905a of FIG. 9).

As discussed in greater detail below with respect to FIGS. 11A and 11B, when the shared memory media 1025 is operably connected to a shared media interface of a UAV, the flight controller and the oversight processor of the UAV can access (e.g., retrieve) all or a subset of the files 1026a-1026c of the secure system parameters package 1026 from the shared memory media 1025. For example, the flight controller can access the files 1026a and 1026b over the shared media interface of the UAV, and the oversight processor can access the files 1026a and 1026c over the shared media interface of the UAV. In this manner, both the flight controller and the oversight processor of the UAV can be provided the same system parameters saved to the shared memory media 1025 in one or more secure system parameters packages. When these system parameters include operational envelope parameters and/or safe landing zone parameters, both the flight controller and the oversight processor of the UAV can be aware of the boundaries of an operational envelope at the site of operation and/or the locations of safe landing zones at the site of operation. Thus, the secure system parameters file 1026a stored on the shared memory media 1025 can serve as a source of truth for system parameters for both the flight controller and the oversight processor.

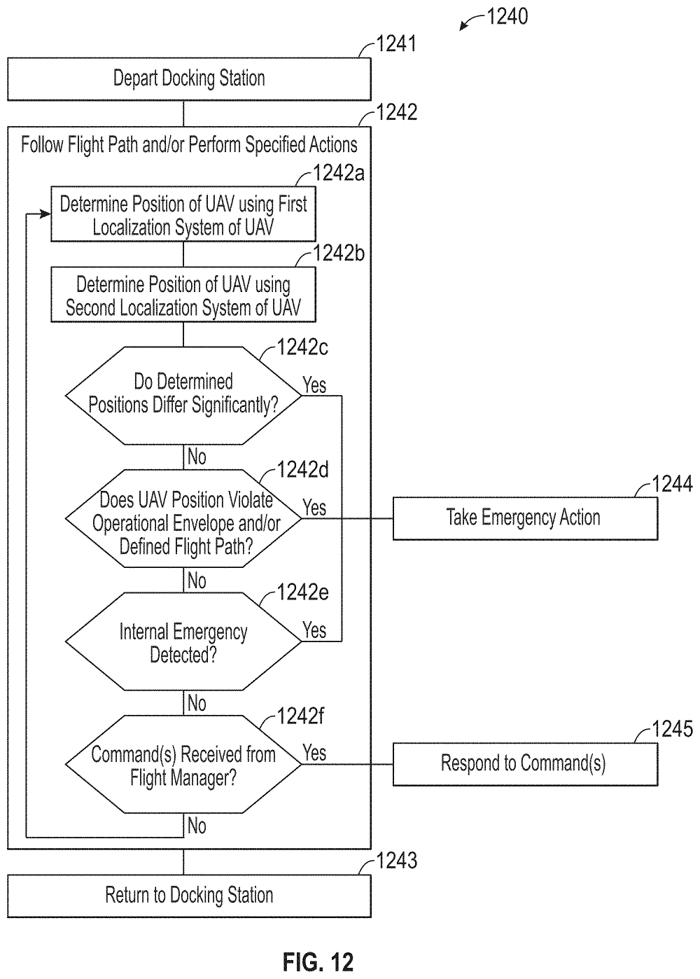

In some embodiments, secure system parameters (e.g., operational envelope parameters and/or safe landing zone parameters) can be provided to the UAV pre-flight, such as before the UAV (e.g., autonomously) executes a flight plan at the site of operation. As discussed in greater detail below with respect to FIG. 12, this can increase the likelihood that the UAV (a) is constrained (via the multi-processor architecture of the UAV) to operate (e.g., to autonomously execute flight plans) within only the operational envelope defined at block 762 of the method 760 and/or (b) is aware of the locations of safe landing zones defined at block 763 at all times during flight. In these and other embodiments, such as in embodiments in which secure system parameters packages are remotely saved to the shared memory media 1025, secure system parameters can be provided to the UAV at any time, such as while the UAV is in flight.

Although the steps of the method 760 are discussed and illustrated in a particular order, the method 760 illustrated in FIG. 7 is not so limited. In other embodiments, the method 760 can be performed in a different order. In these and other embodiments, any of the steps of the method 760 can be performed before, during, and/or after any of the other steps of the method 760. Moreover, a person of ordinary skill in the relevant art will recognize that the illustrated method 760 can be altered and still remain within these and other embodiments of the present technology. For example, one or more steps of the method 760 illustrated in FIG. 7 can be omitted (e.g., the step at block 763) and/or repeated in some embodiments.

FIGS. 11A and 11B are flow diagrams illustrating methods 1130a and 1130b, respectively, for verifying system parameters provided to a multi-processor UAV, in accordance with various embodiments of the present technology. All or a subset of the steps of the methods 1130a and/or 1130b can be executed by various components or devices of a UAV. For example, all or a subset of the steps of the methods 1130a and/or 1130b can be executed by a flight controller and/or an oversight processor of a UAV (e.g., by the flight controller 321 and/or the oversight processor 324 of the UAV 120 of FIGS. 1A, 1B, and 3). Additionally, or alternatively, all or a subset of the steps of the methods 1130a and/or 1130b can be executed by a shared media interface of the UAV (e.g., the shared media interface 325 of FIG. 3) and/or shared memory media (e.g., the shared memory media 1025 of FIG. 10) that is resident on and/or is removably provided to the UAV. Furthermore, any one or more of the steps of the methods 1130a and/or 1130b can be executed in accordance with the discussion above.

For the sake of clarity and explanation, the methods 1130a and 1130b are discussed in part below with occasional reference back to FIGS. 3, 9, and 10, which illustrate a UAV 120, a PKI management architecture 900 and a payload key K_{P} 909, and a shared memory media 1025, respectively. Furthermore, the methods 1130a and 1130b are primarily discussed in detail below as being utilized to verify operational envelope parameters provided to a multi-processor UAV having a flight controller and an oversight processor. A person of ordinary skill in the art will readily recognize that the methods 1130a and/or 1130b can also be used to verify other system parameters (e.g., safe landing zone parameters, firmware, and/or flight plans) provided to the UAV. In some embodiments, the UAV can include a lesser or greater number of (e.g., one or more than two) controllers or processors, such as one or more controllers or processors in addition to or in lieu of the flight controller and/or the oversight processor. Moreover, the methods 1130a and 1130b are discussed below in the context of a boot sequence of a UAV. All or a subset of the steps of the methods 1130a and/or 1130b (e.g., all or a subset of block 1132, of block 1133, of block 1134, and/or of block 1135 of the method 1130a, and/or all or a subset of block 1136, of block 1137, and/or of block 1138 of the method 1130b), however, can be performed outside of a boot sequence of a UAV in some embodiments (e.g., in addition to or in lieu of performing the steps as part of a boot sequence for a UAV). For example, all or a subset of these blocks can be executed in response to an indication that the UAV has been provided (e.g., updated) system parameters and/or with a shared memory media.

Referring first to FIG. 11A, the method 1130a begins at block 1131 by receiving an indication that a UAV is powering up. As discussed above, the UAV for the sake of example is a multi-processor UAV having a flight controller and an oversight processor, such as the UAV 120 of FIG. 3 comprising the flight controller 321 and the oversight processor 324.

At block 1132, the oversight processor (e.g., in response to the indication received at block 1131) holds the flight controller in reset and retrieves system parameters provided to the UAV in one or more secure system parameters package(s) stored in non-volatile memory (e.g., in shared memory media, such as the shared memory media 1025 of FIG. 10). As discussed above, the non-volatile memory can be resident onboard the UAV and/or can be removably provided to the UAV (e.g., via a SD card or other memory medium). In some embodiments, the oversight processor holds the flight controller in reset using a reset line of the UAV. For example, the oversight processor can assert a reset line operably connected to a reset pin of the flight controller to prevent the flight controller from fully executing its boot sequence. In these and other embodiments, the oversight processor retrieves system parameters from the non-volatile memory using a shared media interface (e.g., the shared media interface 325 of FIG. 3) of the UAV.

Referring to FIG. 10, the shared memory media 1025 is one example of non-volatile memory. As shown, the shared memory media 1025 can store a secure system parameters package 1026 that includes files 1026a-1026c. When the shared memory media 1025 is operably connected to a shared memory interface of a UAV, the shared memory media 1025 can provide all or a subset of the files 1026a-1026c to the flight controller and/or to the oversight processor of the UAV. For example, the oversight processor of the UAV can request (via the shared media interface) the secured system parameters file 1026a and/or the file 1026c of the secure system parameters package 1026 from the shared memory media 1025, and/or the shared memory media 1025 can provide (via the shared media interface) the files 1026a and/or 1026c to the oversight processor. For the sake of clarity and explanation, the secure system parameters package 1026 is discussed below as being a secure operational envelope parameters package 1026 having a secured operational envelope parameters file 1026a comprising digitally signed operational envelope parameters. The secure system parameters package 1026 can include other secured system parameters (e.g., safe landing zone parameters, firmware, and/or flight plans) in addition to or in lieu of the operational envelope parameters in other embodiments.

At block 1133 of the method 1130a (FIG. 11A), the oversight processor decrypts one or more files of a secure system parameters package and validates digital signatures. For example, at subblock 1133a, the oversight processor can decrypt a file storing a copy of a payload key K_{P} (e.g., K_{P} 909 of FIG. 9) that corresponds to a payload key K_{P} that was used to encrypt a secured system parameters file included in a secure system parameters package provided to the UAV. In some embodiments, the oversight processor can decrypt the copy of the payload key K_{P} using a private key K_{DO#}^{PRI} provided to the oversight processor, for example, during manufacture of the oversight processor and/or of the UAV.

Referring to FIG. 10 as an example, the oversight processor can decrypt the file 1026c of the secure system parameters package 1026 using the oversight processor's private key K_{DO#}^{PRI}. As discussed above with respect to block 764 of the method 760 illustrated in FIG. 7, the private key K_{DO#}^{PRI} can correspond to a public key K_{DO#}^{PUB} of a device credential K_{DO#} 905 (e.g., the device credential K_{DO#} 905a of FIG. 9). If the oversight processor's private key K_{DO#}^{PRI} corresponds to the specific public key K_{DO#}^{PUB} used to encrypt the file 1026c, the oversight processor can successfully decrypt the file 1026c using the private key K_{DO#}^{PRI} to extract the copy of the payload key K_{P} (e.g., K_{P} 909 of FIG. 9) included in the file 1026c. On the other hand, if the oversight processor is not able to successfully decrypt the file 1026c using the oversight processor's private key K_{DO#}^{PRI}, this can indicate that the oversight processor's private key K_{DO#}^{PRI} does not correspond to the public key K_{DO#}^{PUB} that was used to encrypt the file 1026c.

In some embodiments, the oversight processor's inability to decrypt the file 1026c using the oversight processor's private key K_{DO#}^{PRI} can indicate that the system parameters included within the secured system parameters file 1026a of the secure system parameters package 1026 were not intended for that oversight processor and/or for that UAV. If the oversight processor is unable to decrypt the file 1026c (and/or the file 1026b), the oversight processor is likely also unable to extract the copy of the payload key K_{P} included in the file 1026c. And because the copy of the payload key K_{P} included in the file 1026c corresponds to the payload key K_{P} that was used to encrypt the secured system parameters file 1026a, this means that the oversight processor will also likely be unable to decrypt the secured system parameters file 1026a to extract the system parameters included in the file 1026a. Thus, encrypting the copy of the payload key K_{P} with a public key K_{DO#}^{PUB} that corresponds to a private key K_{DO#}^{PRI} of only a specific oversight processor can increase the likelihood that only the specific oversight processor will be able to successfully decrypt and use the system parameters. This also increases the likelihood that the oversight processor (and/or the UAV) uses only system parameters that were encrypted by a system (e.g., a UAV operational containment system) with knowledge of a public key K_{DO#}^{PUB} that corresponds to the oversight processor's private key K_{DO#}^{PRI}. Stated another way, this decreases the likelihood that the oversight processor of a UAV uses system parameters (e.g., operational envelope parameters) that were not generated and/or encrypted using a trusted system (e.g., a trusted UAV operational containment system of the present technology).

At subblock 1133b, the method 1130a illustrated in FIG. 11A continues by determining whether the oversight processor was successfully able to decrypt and extract the copy of the payload key K_{P} (e.g., the copy of the payload key K_{P} included within the file 1026c of the secure system parameters package 1026 of FIG. 10). If the oversight processor was able to successfully decrypt and extract the copy of the payload key K_{P}, the method 1130a continues to subblock 1133c. Otherwise, the method 1130a proceeds to block 1135 to halt operation of the UAV and/or to trigger an error message.

At subblock 1133c, the method 1130a continues by decrypting a secured system parameters file of the secure system parameters package using the copy of the payload key K_{P} extracted at subblock 1133a. For example, referring again to FIG. 10, the oversight processor can use the copy of the payload key K_{P} it extracted from the decrypted file 1026c at subblock 1133a to decrypt the secured system parameters file 1026a. Assuming that the copy of the payload key K_{P} used by the oversight processor to decrypt the secured system parameters file 1026a corresponds to the payload key K_{P} that was used to encrypt the secured system parameters file 1026a (as discussed above with respect to block 764 of the method 760 of FIG. 7), the oversight processor will likely be able to successfully extract the system parameters and a digital signature included in the file 1026a. On the other hand, if the copy of the payload key K_{P} used by the oversight processor to decrypt the secured system parameters file 1026a does not correspond to the payload key K_{P} used to encrypt the secured system parameters file 1026a, then the oversight processor will likely be unable to successfully extract the system parameters included in the file 1026a. Thus, as discussed above, encrypting the files 1026a and 1026c as shown in FIG. 10 increases the likelihood (i) that only an intended oversight processor (e.g., of an intended UAV) is able to extract and use system parameters included in a secure system parameters package 1026 provided to the UAV, and (ii) that an oversight processor uses only system parameters that were generated and/or encrypted by a trusted system (e.g., a trusted UAV operational containment system of the present technology).

At subblock 1133d, the method 1130a continues by determining whether the oversight processor was successfully able to decrypt the secure system parameters file (e.g., the file 1026a of the secure system parameters package 1026 of FIG. 10) and extract the system parameters and the digital signature included in the file. If the oversight processor was able to successfully decrypt the secure system parameters file, the method 1130a continues to subblock 1133e. Otherwise, the method 1130a proceeds to block 1135 to halt operation of the UAV and/or to trigger an error message.

At subblock 1133e, the method 1130a continues by verifying a digital signature included with (e.g., appended to or otherwise associated with) the system parameters in the secure system parameters file of the secure system parameters package provided to the UAV. As discussed above with respect to block 764 of the method 760 of FIG. 7, system parameters can be digitally signed with a known certificate authority (e.g., with a private key of a data integrity signing credential 915 (FIG. 9) of the PKI architecture 900 (FIG. 9)). Thus, the oversight processor can verify digital signatures using a public key of the data integrity signing credential 915. In some embodiments, the public key of the data integrity signing credential 915 can be provided to the oversight processor in firmware (e.g., previously or concurrently) provided to the oversight processor.

Referring to FIG. 10 again as an example, the secured system parameters file 1026a of the secure system parameters package 1026 of FIG. 10 can include (i) system parameters and (ii) a digital signature (e.g., appended to the system parameters). In embodiments in which the secure system parameters package 1026 is a secure operational envelope parameters package, the system parameters included in the file 1026a can be operational envelope parameters. In these embodiments, the operational envelope parameters can be digitally signed at block 764 of the method 760 of FIG. 7 using a private key K_{BS}^{PRI} of the bounds signing credentials K_{BS} 908 (FIG. 9). Thus, continuing with this example, the oversight processor (at subblock 1133e of the method 1130a of FIG. 11A) can verify the digital signature included in the file 1026a using a public key K_{BS}^{PUB} of the bounds signing credentials K_{BS} 908. If the oversight processor is unable to verify the digital signature using the public key K_{BS}^{PUB}, this can indicate that the secured system parameters file 1026a and/or the system parameters (e.g., the operational envelope parameters) included within the file 1026a have been corrupted or have been tampered with. Therefore, verification of the digital signature increases the likelihood of the UAV using only system parameters (i) that are valid (e.g., not corrupted and/or not tampered with) and (ii) that were generated and/or digitally signed by a trusted system (e.g., a UAV operational containment system with knowledge of the public key of the data integrity signing credential provided to the oversight processor).

At subblock 1133f, the method 1130a continues by determining whether the oversight processor was successfully able to verify the digital signature included with the system parameters. If oversight processor was successfully able to verify the digital signature, the method 1130a (i) can continue to block 1134 where the oversight processor releases the flight controller of the UAV from reset (e.g., using the reset line of the UAV) and/or (ii) can continue to block 1136 of the method 1130b illustrated in FIG. 11B. On the other hand, if the oversight processor is unable to successfully verify the digital signature included with the system parameters, the method 1130a can proceed to block 1135.

At block 1135, the oversight processor halts operation of the UAV and/or triggers an error message. In some embodiments, the oversight processor halts operation of the UAV by keeping the flight controller in reset or by taking another action (e.g., locking up the boot procedure of the UAV, placing the UAV in a standby or idle state, and/or powering down the UAV). This can continue, for example, until the UAV is provided with valid system parameters. As discussed above, halting operation of the UAV when the oversight processor (a) is unable to decrypt a file in a secure system parameters package or (b) is unable to verify a digital signature included with system parameters in the secure system parameters package, can increase the likelihood the oversight processer uses (i) only system parameters specifically intended for the oversight processor; (ii) only system parameters that were generated, encrypted, and/or digitally signed by a trusted system (e.g., a UAV operational containment system of the present technology); and/or (iii) only systems parameters that are valid (e.g., parameters that are not corrupted and/or have not been tampered with).

In some embodiments, the error message triggered by the oversight processor can specify the type of error encountered. For example, the triggered error message can specify that the oversight processor was unable to decrypt the copy of the payload key K_{P} of a secure system parameters package, the oversight processor was unable to decrypt the secure system parameters file of the secure system parameters package, and/or the oversight processor was unable to verify the digital signature included in the secure system parameters file. In these and other embodiments, the oversight processor can instruct the UAV to transmit the error message to a UAV operational containment system (e.g., to a flight manager of the UAV operational containment system) and/or to a user (e.g., an operator, a field technician, and/or a service technician) of the system.

Referring now to FIG. 11B, the method 1130b can begin at block 1136 by the flight controller of the UAV retrieving system parameters provided to the UAV in one or more secure system parameters package(s) stored in non-volatile memory (e.g., in shared memory media, such as the shared memory media 1025 of FIG. 10). In some embodiments, the flight controller can retrieve the system parameters once the oversight processor of the UAV releases the flight controller from reset (as discussed above with respect to block 1134 of the method 1130a of FIG. 11A).

In some embodiments, the non-volatile memory can be the non-volatile memory discussed above with respect to block 1132 of the method 1130a. For example, the flight controller can retrieve system parameters from the non-volatile memory using the same or similar shared media interface of the UAV that the oversight processor used to retrieve system parameters from the non-volatile memory. Continuing with this example, the non-volatile memory can therefore be the shared memory media 1025 of FIG. 10. Thus, in these embodiments, the flight controller of the UAV can request (via the shared media interface) the secured system parameters file 1026a and/or the file 1026b of the secure system parameters package 1026 stored on the shared memory media 1025, and/or the shared memory media 1025 can provide (via the shared media interface) the files 1026a and/or 1026b to the flight controller.

At block 1137 of the method 1130b, the flight controller decrypts one or more files of a secure system parameters package and validates digital signatures. In some embodiments, the procedure executed by the flight controller at block 1137 of the method 1130b can be similar to the procedure executed by the oversight processor at block 1133 of the method 1130 (FIG. 11A). For example, at subblock 1137a, the flight controller can decrypt a file storing a copy of a payload key K_{P} (e.g., K_{P} 909 of FIG. 9) that corresponds to a payload key K_{P} used to encrypt a secure system parameters file included in a secure system parameters package provided to the UAV. In some embodiments, the flight controller can decrypt the copy of the payload key K_{P} using a private key K_{DC#}^{PRI} provided to the flight controller, for example, during manufacture of the flight controller and/or of the UAV.

Referring to FIG. 10 as an example, the flight controller can decrypt the file 1026b of the secure system parameters package 1026 using the flight controller's private key K_{DC#}^{PRI}. As discussed above with respect to block 764 of the method 760 illustrated in FIG. 7, the private key K_{DC#}^{PRI} can correspond to a public key K_{DC#}^{PUB} of a device credential K_{DC#} 903 (e.g., the device credential K_{DC#} 903a of FIG. 9). If the flight controller's private key K_{DC#}^{PRI} corresponds to the specific public key K_{DC#}^{PUB} used to encrypt the file 1026b, the flight controller can successfully decrypt the file 1026b using private key K_{DC#}^{PRI} to extract the copy of the payload key K_{P} (e.g., K_{P} 909 of FIG. 9) included in the file 1026b. On the other hand, if flight controller is not able to decrypt the file 1026b using the flight controller's private key K_{DC#}^{PRI}, this can indicate that the flight controller's private key K_{DC#}^{PRI} does not correspond to the public key K_{DC#}^{PUB} that was used to encrypt the file 1026b.

In some embodiments, the flight controller's inability to decrypt the file 1026b using the flight controller's private key K_{DC#}^{PRI} can indicate that the system parameters included within the secured system parameters file 1026a of the secured system parameters package 1026 were not intended for that flight controller and/or for that UAV. If the flight controller is unable to decrypt the file 1026b (and/or the file 1026c), the flight controller is likely also unable to extract the copy of the payload key K_{P} included in the file 1026b. And because the copy of the payload key K_{P} included in the file 1026b corresponds to the payload key K_{P} that was used to encrypt the secured system parameters file 1026a, this means that the flight controller will also likely be unable to decrypt the secured system parameters file 1026a to extract the digitally signed system parameters included in the file 1026a. Thus, encrypting the copy of the payload key K_{P} with a public key K_{DC#}^{PUB} that corresponds to a private key K_{DC#}^{PRI} of only a specific flight controller can increase the likelihood that only the specific flight controller will be able to successfully decrypt and use the system parameters. This also increases the likelihood that the flight controller (and/or the UAV) uses only system parameters that were encrypted by a system (e.g., a UAV operational containment system) with knowledge of a public key K_{DC#}^{PUB} that corresponds to the flight controller's private key K_{DC#}^{PRI}. Stated another way, this decreases the likelihood that the flight controller of a UAV uses system parameters (e.g., operational envelope parameters) that were not generated and/or encrypted using a trusted system (e.g., a trusted UAV operational containment system of the present technology).

At subblock 1137b, the method 1130b illustrated in FIG. 11B continues by determining whether the flight controller was successfully able to decrypt and extract the copy of the payload key K_{P} (e.g., the copy of the payload key K_{P} included within the file 1026b of the secure system parameters package 1026 of FIG. 10). If the flight controller was able to successfully decrypt and extract the copy of the payload key K_{P}, the method 1130b continues to subblock 1137c. Otherwise, the method 1130b proceeds to block 1138 to halt operation of the UAV and/or to trigger an error message.

At subblock 1137c, the method 1130b continues by decrypting a secured system parameters file of the secure system parameters package using the copy of the payload key K_{P} extracted at subblock 1137a. For example, referring again to FIG. 10, the flight controller can use the copy of the payload key K_{P} it extracted from the decrypted file 1026b at subblock 1137a to decrypt the secured system parameters file 1026a. Assuming that the copy of the payload key K_{P} used by the flight controller to decrypt the secured system parameters file 1026a corresponds to the payload key K_{P} that was used to encrypt the in the secured system parameters file 1026a (as discussed above with respect to block 764 of the method 760 of FIG. 7), the flight controller will likely be able to successfully extract the system parameters and a digital signature included in the file 1026a. On the other hand, if the payload key K_{P} used by the flight controller to decrypt the secured system parameters file 1026a does not correspond to the payload key K_{P} that was used to encrypt the secured system parameters file 1026a, then the flight controller will likely be unable to successfully extract the system parameters included in the file 1026a. Thus, as discussed above, encrypting the files 1026a and 1026b as shown in FIG. 10 increases the likelihood (i) that only an intended flight controller (e.g., of an intended UAV) is able to extract and use system parameters included in a secure system parameters package 1026 provided to the UAV, and (ii) that a flight controller uses only system parameters that were generated and/or encrypted by a trusted system (e.g., a trusted UAV operational containment system of the present technology).

At subblock 1137d, the method 1130b continues by determining whether the flight controller was successfully able to decrypt the secure system parameters file (e.g., the file 1026a of the secure system parameters package 1026 of FIG. 10) and extract the system parameters and the digital signature included in the file. If the flight controller was able to successfully decrypt the secure system parameters file, the method 1130b continues to subblock 1137e. Otherwise, the method 1130b proceeds to block 1138 to halt operation of the UAV and/or to trigger an error message.

At subblock 1137e, the method 1130b continues by verifying a digital signature included with (e.g., appended to or otherwise associated with) the system parameters in the secure system parameters file of the secure system parameters package provided to the UAV. As discussed above with respect to block 764 of the method 760 of FIG. 7, system parameters can be digitally signed with a known certificate authority (e.g., with a private key of a data integrity signing credential 915 (FIG. 9) of the PKI architecture 900 (FIG. 9)). Thus, the flight controller can verify digital signatures using a public key of the data integrity signing credential 915. In some embodiments, the public key of the data integrity signing credential 915 can be provided to the flight controller in firmware (e.g., previously or concurrently) provided to the flight controller.

Referring to FIG. 10 again as an example, the secured system parameters file 1026a of the secure system parameters package 1026 of FIG. 10 can include (i) system parameters and (ii) a digital signature (e.g., appended to the system parameters). In embodiments where the secure system parameters package 1026 is a secure operational envelope parameters package, the system parameters included in the file 1026a can be operational envelope parameters. In these embodiments, the operational envelope parameters can be digitally signed at block 764 of the method 760 of FIG. 7 using a private key K_{BS}^{PRI} of the bounds signing credentials K_{BS} 908 (FIG. 9). Thus, continuing with this example, the flight controller (at subblock 1137e of the method 1130b of FIG. 11B) can verify the digital signature included in the file 1026a using a public key K_{BS}^{PUB} of the bounds signing credentials K_{BS} 908. If the flight controller is unable to verify the digital signature using the public key K_{BS}^{PUB}, this can indicate that the secured system parameters file 1026a and/or the system parameters (e.g., the operational envelope parameters) included within the file 1026a have been corrupted or have been tampered with. Therefore, verification of the digital signature increases the likelihood of the UAV using only system parameters (i) that are valid (e.g., not corrupted and/or not tampered with) and (ii) that were generated and/or digitally signed by a trusted system (e.g., a UAV operational containment system with knowledge of the public key of the data integrity signing credential provided to the flight controller).

At subblock 1137f, the method 1130b continues by determining whether the flight controller was successfully able to verify the digital signature included with the system parameters. If flight controller was successfully able to verify the digital signature, the method 1130b (i) can continue to block 1139 where the flight controller permits the UAV to continue executing its boot sequence and/or to execute other normal operations of the UAV. At this point, both the oversight processor and the flight controller can be fully booted with verified system parameters at their disposal. On the other hand, if the flight controller is unable to successfully verify the digital signature included with the system parameters, the method 1130b can proceed to block 1138.

At block 1138, the flight controller halts operation of the UAV and/or triggers an error message. In some embodiments, the flight controller halts operation of the UAV by locking up the boot procedure of the UAV, placing the UAV in a standby or idle state, powering down the UAV, and/or otherwise preventing the UAV from continuing to execute its boot sequence and/or from executing other operations (e.g., flight operations). This can continue, for example, until the UAV is provided with valid system parameters. As discussed above, halting operation of the UAV when the flight controller (a) is unable to decrypt a file in a secure system parameters package or (b) is unable to verify a digital signature included with system parameters in the secure system parameters package, can increase the likelihood the flight controller uses (i) only system parameters specifically intended for the flight controller; (ii) only system parameters that were generated, encrypted, and/or digitally signed by a trusted system (e.g., a UAV operational containment system of the present technology); and/or (iii) only systems parameters that are valid (e.g., parameters that are not corrupted and/or have not been tampered with).

In some embodiments, the error message triggered by the flight controller can specify the type of error encountered. For example, the triggered error message can specify that the flight controller was unable to decrypt the copy of the payload key KP of a secure system parameters package, the flight controller was unable to decrypt the secure system parameters file of the secure system parameters package, and/or the flight controller was unable to verify the digital signature included in the secure system parameters file). In these and other embodiments, the flight controller can instruct the UAV to transmit the error message to a UAV operational containment system (e.g., to a flight manager of the UAV operational containment system) and/or to a user (e.g., an operator, a field technician, and/or a service technician) of the system.

Although the steps of the methods 1130a and 1130b are discussed and illustrated in FIGS. 11A and 11B, respectively, in a particular order, the methods 1130a and 1130b are not so limited. In other embodiments, the methods 1130a and/or 1130b can be performed in a different order. In these and other embodiments, any of the steps of the methods 1130a and/or 1130b can be performed before, during, and/or after any of the other steps of the methods 1130a and/or 1130b. Moreover, a person of ordinary skill in the relevant art will recognize that the illustrated methods 1130a and/or 1130b can be altered and still remain within these and other embodiments of the present technology. For example, one or more steps of the methods 1130a and/or 1130b illustrated in FIGS. 11A and 11B, respectively, can be omitted and/or repeated in some embodiments.

FIG. 12 is a flow diagram illustrating a method 1240 of executing a flight plan in accordance with various embodiments of the present technology. All or a subset of the steps of the method 1240 can be executed by various components or devices of a UAV operational containment system (“the system”), such as the system 100 illustrated in FIGS. 1A and 1B or other suitable systems. In these and other embodiments, all or a subset of the steps of the method 1240 can be executed by components or devices of a UAV, such as the multi-processor UAV 120 (FIGS. 1A, 1B, and 3). Furthermore, any one or more of the steps of the method 1240 can be executed in accordance with the discussion above.

As discussed in greater detail below, redundant localization systems on a UAV can facilitate safe operation of the UAV even in the event that one of the localization systems fails, malfunctions, or is otherwise compromised (e.g., hacked). Additionally, the multi-processor architecture of the UAV can facilitate safe operation of the UAV even in the event that a controller or processor that handles main flight operations fails, malfunctions, or is otherwise compromised (e.g., hacked). For example, system parameters defining operational boundaries for a UAV can be provided (e.g., pre-flight) to the UAV. As discussed in greater detail above with respect to FIG. 3, the UAV can include a flight controller that controls main flight operations of the UAV in accordance with the system parameters. Furthermore, the UAV can include an oversight processor that monitors the flight controller's adherence to the system parameters. Because the oversight processor can have access to the same system parameters ad the flight controller (as discussed above with respect to FIGS. 11A and 11B), the oversight processor can oversee operation of the flight controller in relation to the system parameters and can intercede when it determines that the flight controller is operating in violation of the system parameters. A more detailed explanation of this process is provided below with respect to blocks 1241-1245 of FIG. 12.

The method 1240 of FIG. 12 begins at block 1241 by the UAV departing from a docking station of a UAV inspection system in response to a command received from (e.g., a scheduler module of) a flight manager (e.g., the flight manager 110 of FIGS. 1A-2). In some embodiments, the UAV is permitted to depart from the docking station and begin executing a flight plan only when the UAV passes a pre-flight inspection, when all components (e.g., the control tower, the navigation beacons, the UAV inspection system) of the system are connected to the flight manager, when environmental (e.g., weather and/or air traffic) conditions are conducive to the UAV safely and successfully executing the flight plan within the operational envelope of the UAV, and/or when the flight plan is in compliance with current flight restrictions and/or NOTAMs. Pre-flight inspections and airspace authorizations are discussed in greater detail in U.S. patent application Ser. No. 17/179,970.

Under normal, safe, and/or successful execution of a flight plan, the UAV autonomously performs blocks 1242 and 1243 (including subblocks 1242a-1242f of the block 1242) without ever proceeding to blocks 1244 and/or 1245. That is, the UAV departs the docking station at block 1241, executes a flight plan at block 1242 by following a flight path and performing specified actions defined in the flight plan, and returns to the docking station at block 1243. Stated another way, the UAV typically (a) proceeds to block 1244 only in the event that the UAV identifies an in-flight emergency and/or (b) proceeds to block 1245 only in the event that (i) the flight manager identifies an in-flight emergency, (ii) a user of the system takes manual control of the UAV via the flight manager, and/or (iii) the flight manager transmits navigation commands to the UAV. Blocks 1242-1245 (including subblocks 1242a-1242f) are discussed in greater detail below.

At block 1242, the method 1240 continues by following a flight path defined in the flight plan and/or by performing actions specified in the flight plan. To follow the defined flight path, the flight controller of the UAV manages the UAV's position in three-dimensional space, adjusting the UAV's current position in space to align with a next position in space defined by the flight path. As part of this process, the UAV uses redundant localization systems to determine its current position in space. For example, at subblock 1242a, the UAV determines a position of the UAV using a first localization system, such as the UAV's onboard GPS system. Additionally, at subblock 1242b, the UAV determines a position of the UAV using a second localization system independent of and different from the first localization system. For example, the second localization system can be the UAV's onboard RF localization system. In some embodiments, an altitude determined by the first localization system and/or the second localization system can be verified using a separate system or sensor (e.g., a pressure sensor) onboard the UAV. In these and other embodiments, the UAV reports the position determined using the first localization system and/or the position determined using the second localization system to the flight manager and/or other components of the system.

In one embodiment, the UAV's RF localization system determines the position of the UAV in space by communicating with control tower(s) and/or navigation beacons of a UAV operational containment system and deployed at the site of operation. In particular, the RF localization system determines which control tower(s) and/or navigation beacons are in the UAV's vicinity and continually pings those control tower(s) and/or navigation beacons with information packets. For example, the RF localization system determines which control tower(s) and/or navigation beacons are in its vicinity by comparing a current position of the UAV (i) to positional information of the control tower(s) and navigation beacons provided to the UAV by the flight manager pre-flight and/or (ii) to updated positional information of the control tower(s) and navigation beacons provided to the UAV during flight. Starting with control tower(s) and/or navigation beacons of the system having positions closest to the UAV's current position, the RF localization system can attempt to communicate with these control tower(s) and/or navigation beacons by pinging them with information packets. If attempts to communicate with a control tower or a navigation beacon are unsuccessful, the RF localization system can attempt to communicate with a next closest control tower and/or navigation beacon to the UAV's current position and continue with this process at least until the RF localization is successfully able to communicate with three components of the system comprising control tower(s) and/or navigation beacons. Failure to successfully communicate with at least three components of the system can indicate (i) a control tower and/or a navigation beacon has lost connectivity with the system, and/or (ii) deployment of the control tower(s) and/or the navigation beacons at the site of operation is deficient (e.g., is not providing blanket LAN coverage to the site of operation or to at least the operational envelope of the UAV). As discussed in greater detail below with respect to subblock 912e, the UAV can proceed to block 914 to take emergency action when the UAV is unable to successfully communicate with at least three components of the system.

When attempts to communicate with a control tower or a navigation beacon are successful, the control tower or navigation beacon immediately returns an information packet received from the UAV back to the UAV. In turn, the UAV determines the RTT of the information packet and converts the RTT into a physical distance between the UAV and that control tower or navigation beacon using the speed of light and known dynamics of the network. The above process is repeated for other control towers and/or navigation beacons in the UAV's vicinity and with which the UAV is successfully able to communicate.

Because the RTT of information packets can vary depending on the size of the packet, the size of information packets sent between the UAV and the control tower(s) or navigation beacons are kept small and/or relatively constant. For example, an information packet may include only a packet ID, a media access control (MAC) address of a control tower's or navigation beacon's (e.g., LAN or mesh) network radio to which the information packet is addressed, and/or a message type identifier (e.g., an RTT message type identifier) to minimize processing of the packet by the control tower of the navigation beacon and reduce the time elapsed before the control tower or the navigation beacon returns the information packet to the UAV.

Using (a) multiple (e.g., three or more) physical distances determined between multiple (e.g., three of more) control towers and/or navigation beacons of the system and (b) the known locations of those control towers and/or navigation beacons, the RF localization system can calculate the position of the UAV in space using, for example, trilateration. The precise locations of the control towers and/or navigation beacons are known because (i) each of these components includes an onboard GPS that is used to report its positional information to the flight manager before execution of the flight plan and (ii) the flight manager provides the UAV with this positional information pre-flight and/or whenever the positional information for a control tower and/or a navigation beacon is updated during flight of the UAV.

At subblock 1242c, after the UAV obtains the position of the UAV determined using the first localization system at subblock 1242a and the position of the UAV determined using the second localization system at subblock 1242b, the UAV proceeds to compare these determined positions to one another. Any difference between these determined positions of the UAV can be compared to one or more difference thresholds to determine whether the positions differ from one another to an extent that there is cause for concern. For example, if a difference between the determined positions exceeds a difference threshold, the method 1240 can proceed to block 1244 such that the UAV takes emergency action. Otherwise, the method 1240 can proceed to subblock 1242d.

In the event the UAV uses multiple difference thresholds for the comparison performed at subblock 1242c, the emergency action taken by the UAV at block 1244 can depend on which of the difference thresholds are exceeded. For example, if the difference between the determined positions of the UAV exceed a first difference threshold but not a second difference threshold, the UAV can take emergency action (a) by slowing its velocity and/or hovering in place and (b) waiting for a recalculated position of the UAV determined used the first localization system and/or a second recalculated position of the UAV determined using the second localization system, to stabilize and come back into alignment. If the recalculated positions come back into alignment within a specified period of time, the method 1240 can return to block 1242 and/or proceed to subblock 1242d.

On the other hand, if the recalculated positions do not come back into alignment within the specified amount of time and/or if the difference between the originally determined positions exceeds both the first and second difference thresholds, the UAV can (i) execute an emergency flight plan included in the flight plan and proceed to land at a safe landing zone defined in the emergency flight plan for a portion of the flight path corresponding to the UAV's current (or last known) position, and/or (ii) deploy an emergency parachute of the UAV, allowing the UAV to safely drop to the ground. Emergency flight plans and safe landing zones are discussed in greater detail in U.S. patent application Ser. No. 17/179,970.

Failure of the recalculated positions to stabilize or come back into alignment can indicate a hardware malfunction or a potential compromise (e.g., hack) of one of the UAV's localization systems. In some embodiments, a notification is sent to a service technician to investigate the cause of the difference between the determined and/or recalculated positions. In these and other embodiments, the UAV can return to block 1242 and/or proceed to subblock 1242d if the recalculated positions of the UAV come into alignment (e.g., within a specified period of time) when the UAV is executing the emergency flight plan and/or after the UAV has successfully landed at the corresponding safe landing zone. In this manner, the redundant localization systems onboard the UAV increases the likelihood of safe operation of the UAV, even in the event that one of the localization systems fails, malfunctions, or is otherwise compromised (e.g., is hacked).

At subblock 1242d, the method 1240 continues by determining whether the current position of the UAV (a) is approaching a violation of or is already violating the UAV's operational envelope or (b) is deviating from the flight path defined in the flight plan. As discussed above with respect to FIG. 3, the positions of the UAV determined using the first and second localization systems of the UAV are sent to both the flight controller and the oversight processor of the UAV. As such, the oversight processor can check (a) the current position of the UAV (as defined by the positions of the UAV determined using the first and second localization system of the UAV) and/or (b) the UAV's current trajectory, velocity, and/or acceleration to determine if the UAV is about to violate or is currently violating its operational envelope (e.g., operational envelope parameters provided to the UAV at block 765 of the method 760 (FIG. 7) and/or verified by the oversight processor at block 1133 of the method 1130a (FIG. 11A)). In the event the oversight processor determines that the UAV is not currently in violation of the UAV's operational envelope but is approaching a violation, the oversight processor can notify the flight controller of an impending violation, and the flight controller can take corrective action. If (i) the flight controller fails to take corrective action, (ii) violation of the operational envelope is likely or inevitable, and/or (iii) the current position of the UAV violates the UAV's operational envelope, the method 1240 can proceed to block 1244 such that the UAV takes emergency action. A similar procedure can be performed if the flight controller and/or the oversight processor determine that the UAV is deviating from the flight path defined in the flight plan by more than one or more deviation thresholds.

If the method 1240 proceeds to block 1244 from subblock 1242d, the UAV can be configured to take one or more emergency actions. In some embodiments, the oversight processor of the UAV communicates with the flight controller over a uni-directional communications line to trigger an alert or alarm, reduce operational velocity of the UAV, force execution of alternate instructions (e.g., to hover in place, to immediately return the UAV to within the operational envelope and/or to the flight path, to land the UAV within a safe landing zone designated in the emergency flight plan, to return the UAV to the docking station, and/or to perform another action to attempt to bring the UAV back into a safe operating state), to execute a gradual shutdown procedure, and/or to temporarily or permanently disable the UAV. Additionally, or alternatively, the oversight processor can employ a flight termination system. For example, the oversight processor can assert a reset signal over a uni-directional reset communications line to permanently or temporarily cease functionality of the flight controller and/or the oversight processor can deploy an emergency parachute of the UAV (allowing the UAV to safely drop to the ground). In this manner, the UAV continually checks its position against its operational envelope and/or the defined flight path, and the multi-processor architecture of the UAV increases the likelihood of safe operation of the UAV, even in the event that the flight controller fails, malfunctions, or is otherwise compromised (e.g., is hacked).

On the other hand, if the oversight processor detects no current or impending violation of the UAV's operational envelope, and/or if the flight controller and/or the oversight processor detect no significant deviation (e.g., deviation above one or more deviation thresholds) from the flight plan, the method 1240 can proceed to subblock 1242e.

At subblock 1242e, the method 1240 continues by determining whether any internal emergencies of the UAV have been detected. Examples of internal emergencies of the UAV include loss of connectivity to various components (e.g., to the control tower(s), the navigation beacons, and/or the flight manager) of the system when using an RF localization system; failure to successfully send/receive information packets to at least three components (e.g., comprising control tower(s) and/or navigation beacons) of the system; and/or failure, malfunction, or other compromise (e.g., hack) of a UAV sensor or system. In some embodiments, the UAV can use various systems and/or sensors (e.g., an onboard accelerometer) to determine whether the UAV is exhibiting abnormal flight behavior indicative of failure, malfunction, or other compromise (e.g., hack) of a UAV sensor or system. In the event that an internal emergency is detected at subblock 1242e, the method 1240 proceeds to block 1244 such that the UAV takes emergency action. Otherwise, the method 1240 proceeds to subblock 1242f.

In the event the method 1240 proceeds to block 1244 from subblock 1242e, the UAV can be configured to take one or more emergency actions dependent, for example, of the type and/or severity of the internal emergency detected. For example, in the event that the UAV loses connectivity with components of the system and/or is unable to send/receive information packets to at least three components (comprising control tower(s) and/or navigation beacons) of the system when using an RF localization system, the UAV can hover in place and wait for connectivity and/or communication with at least three components to be restored. Additionally, or alternatively, the UAV can (e.g., immediately or after hovering in place for a specified period of time) execute the portion of the emergency flight plan corresponding to the UAV's current position along the flight path, land at the designated safe landing zone, and wait for connectivity/communication to be restored. In some embodiments, if connectivity and/or communication is restored, the method 1240 can return to block 1242 and/or proceed to subblock 1242f. If connectivity and/or communication is permanently lost, the UAV can stay grounded at the safe landing zone until a field technician is deployed to investigate, debug, and restore connectivity and/or communication.

As another example, in the event that the UAV identifies that an onboard system and/or sensor has failed, is malfunctioning, and/or is otherwise compromised (e.g., is hacked), the UAV can determine whether the UAV is stable and can be safely maneuvered to the ground. If the UAV is stable, the UAV can (i) execute the portion of the emergency flight plan corresponding to the UAV's current position along the flight path, (ii) land at the designated safe landing zone, and (iii) wait for a service technician to investigate. On the other hand, if the UAV determines that the UAV is unstable (e.g., that a propeller has failed), the UAV can kill its motors and deploy an emergency parachute to allow the UAV to safely drop to the ground. A notification can be sent to a service technician to investigate.

At subblock 1242f, the method 1240 continues by determining whether the UAV has received a command from the flight manager. For example, when a position of a control tower and/or a navigation beacon of the system has changed while the UAV is in flight, the flight manager can instruct the UAV to hover in place (e.g., at least until the UAV receives the updated positions of the control tower(s) and/or the navigation beacons from the flight manager). Thus, when the UAV receives instructions from the UAV to hover in place, the method 1240 proceeds to block 1245 and the UAV executes the hover and update position commands.

As another example, a user can opt to take manual control of the UAV via the webserver portal of the flight manager. In this event, the flight manager transmits commands to the UAV corresponding to the manual commands received from the user. Thus, when the UAV receives the manual control commands, the method 1240 proceeds to block 1245 and the UAV executes the manual control commands.

As yet another example, the navigation beacons, control tower, and flight manager can continuously capture data related to (and/or can continuously monitor environmental conditions of) the site of operation while the UAV executes the flight plan. In these embodiments, the flight manager can identify external emergencies that can jeopardize the safe and/or successful execution of the flight plan based at least in part on the captured data and/or environmental conditions. As such, the flight manager can generate commands for the UAV to execute in response to identifying an external emergency and can transmit these commands to the UAV. When the UAV receives these commands, the method 1240 can proceed from subblock 1242f to block 1245 to execute the commands. Examples of commands that the flight manager can transmit to the UAV and that the UAV can execute include taking evasive action (e.g., by deviating from the flight path), hovering in place (e.g., for a specified period of time), returning to the docking station, and/or executing a portion of the emergency flight plan corresponding to the UAV's current position to land at a safe landing zone. In some embodiments, the method 1240 can return to block 1242 after there is no longer an external emergency (e.g., after there is no longer a risk of collision or other interference between the UAV and another object, after safe weather conditions have returned, and/or after another scenario posing a risk to the UAV has passed). Identification of external emergencies and operations executed by a flight manager while the UAV is executing a flight plan is discussed in greater detail in U.S. patent application Ser. No. 17/179,970.

If no commands are received from the flight manager at subblock 1242f, the method 1240 can return to subblock 1242a, and the subblocks 1242a-1242f can be repeated until the UAV completes traversing the defined flight path and/or performing the actions specified in the flight plan. At that point, the method 1240 can proceed to block 1243 to land the UAV at the docking station.

Although the steps of the method 1240 are discussed and illustrated in a particular order, the method 1240 illustrated in FIG. 12 is not so limited. In other embodiments, method 1240 can be performed in a different order. In these and other embodiments, any of the steps of the method 1240 can be performed before, during, and/or after any of the other steps of the method 1240. Moreover, a person of ordinary skill in the relevant art will recognize that the illustrated method 1240 can be altered and still remain within these and other embodiments of the present technology. For example, one or more steps of the method 1240 illustrated in FIG. 12 can be omitted and/or repeated in some embodiments.

Embodiments of the present technology therefore provide UAVs, including multi-processor UAVs with secured system parameters (and associated systems, devices, and methods), that facilitate safe, autonomous operation of the UAVs in BVLOS scenarios. For example, the present technology provides UAV operational containment systems that facilitate defining operational envelopes for UAVs tailored to any site of operation. The UAV operational containment systems also facilitate securing system parameters (e.g., digitally signing and/or encrypting operational envelope and/or other system parameters using, for example, a PKI management architecture and/or a payload key) in such a way that a same data payload including the system parameters (i) can be delivered to and/or shared between each of two or more controllers or processors of a UAV, yet (ii) can be verified and/or reserved for use by only specific controllers or processors of the UAV. This can increase the likelihood that the controllers or processors of a UAV receive valid (e.g., not corrupted and/or tampered with) system parameters and that only intended controllers or processors on an intended UAV have access to, can verify, and/or can use the system parameters.

Embodiments of the present technology also facilitate decrypting and verifying (e.g., using a PKI management architecture and/or a payload key) system parameters provided to a UAV. This can increase the likelihood that the UAV only uses system parameters (i) that are intended for the UAV, (ii) that are digitally signed and/or encrypted by a trusted UAV operational containment system, and (iii) that are valid (e.g., not corrupted and/or tampered with). In addition, by tying the verification procedure to a UAV's boot sequence, embodiments of the present technology increase the likelihood that the UAV does not (e.g., autonomously) execute a flight plan without valid operational envelope parameters. Furthermore, redundant localization systems and/or multiple (e.g., two or more) processors on the UAVs increase the likelihood that the UAVs are bound to and remain within the defined operational envelopes. Moreover, embodiments of the present technology facilitate identifying and responding to emergencies both internal and external the UAVs. Thus, in the event the an emergency is identified during flight of a UAV, the UAV can quickly and safely respond to the emergency (e.g., by executing one or more actions specified in commands received from the flight manager, by executing an emergency flight plan corresponding to the UAV's current position along its flight path to land at one of the safe landing zones at the site of operation, by deploying an emergency parachute and floating to the ground, and/or by taking another appropriate action, such as reducing operational velocity and/or hovering in place).

### C. Additional Examples

Several aspects of the present technology are set forth in the following examples. Although several aspects of the present technology are set forth below in examples directed to systems and methods, these aspects of the present technology can similarly be set forth in examples directed to methods and systems, respectively, in other embodiments. Additionally, or alternatively, these aspects of the present technology may be set forth in examples directed to non-transitory, computer-readable media in other embodiments.

1. An autonomously operating unmanned aerial vehicle (UAV), comprising:
a flight controller configured to manage flight operations of the autonomously operating UAV;
an oversight processor configured to oversee the flight operations of the flight controller; and
a media interface operably connected to the flight controller and to the oversight processor, wherein:
   the flight controller and the oversight processor are each configured to (i) receive, over the media interface, system parameters stored in non-volatile memory, and (ii) verify the system parameters before executing autonomous flight operations, and
   the system parameters include operational envelope parameters for the autonomously operating UAV defining an operational envelope that specifies airspace at a site of operation to which autonomous flight of the autonomously operating UAV is constrained.

2. The autonomously operating UAV of example 1, wherein, to verify the system parameters, the flight controller and the oversight processor are each configured to:
decrypt a payload key using a device credential unique to only the flight controller or to only the oversight processor;
decrypt the system parameters using the decrypted payload key to extract the system parameters and a digital signature associated with the system parameters; and
verify the digital signature before using the system parameters.

3. The autonomously operating UAV of example 1 or example 2, wherein, based at least in part on an indication that the autonomously operating UAV is powering on, the oversight processor is further configured to hold the flight controller in reset until the oversight processor successfully verifies the system parameters.

4. The autonomously operating UAV of any of examples 1-3, further comprising a plurality of localization systems and a parachute, wherein:
each localization system of the plurality of localization systems is configured to determine a position of the autonomously operating UAV and to provide the position to the oversight processor;
the oversight processor is configured to (i) compare one or more positions determined by one or more localization systems of the plurality of localization systems to the operational envelope, and (ii) execute an emergency action when the oversight processor determines that the one or more positions violate the operational envelope for the UAV; and
the emergency action includes (i) asserting a reset pin of the flight controller to cease functionality of the flight controller and (ii) deploying the parachute.

5. The autonomously operating UAV of any of examples 1-5, further comprising a plurality of localization systems, wherein:
each localization system of the plurality of localization systems is configured to determine a position of the autonomously operating UAV and to provide the position to the flight controller; and
the flight controller is configured to (i) determine a difference between a first position of the autonomously operating UAV determined by a first localization system of the plurality of localization systems and a second position of the autonomously operating UAV determined by a second localization system of the plurality of localization systems, and (ii) execute an emergency action when the difference exceeds a threshold.

6. An unmanned aerial vehicle (UAV), comprising:
a flight controller configured to control flight operations of the UAV based at least in part on system parameters provided to the UAV; and
an oversight processor different from the flight controller and configured to (i) monitor operations of the flight controller and (ii) intercede when the oversight processor determines the flight controller is operating in violation of the system parameters.

7. The UAV of example 6, further comprising a shared media interface, wherein the shared media interface is configured to operably connect non-volatile memory storing the system parameters to the flight controller and to the oversight processor.

8. The UAV of example 7, further comprising the non-volatile memory, wherein the non-volatile memory is configured to provide the system parameters to the flight controller and the oversight processor over the shared media interface.

9. The UAV of any of examples 6-8, wherein the system parameters include operational envelope parameters that define an operational envelope for the UAV, and wherein the operational envelope for the UAV specifies airspace at a site of operation within which flight of the UAV is constrained.

10. The UAV of any of examples 6-9, further comprising a plurality of localization systems, wherein each localization system in the plurality of localization systems is configured to determine a position of the UAV independent of other localization systems of the plurality of localization systems.

11. The UAV of example 10, wherein the plurality of localization systems includes a global positioning system (GPS) and a radiofrequency (RF) localization system.

12. The UAV of example 10 or example 11, wherein each localization system of the plurality of localization systems is configured to provide the position of the UAV to the flight controller and to the oversight processor.

13. The UAV of example 10 or example 11, wherein the plurality of localization systems includes:
a first subset of localization systems configured to provide the position of the UAV to only the flight controller; and
a second subset of localization systems configured to provide the position of the UAV to only the oversight processor.

14. The UAV of any of examples 6-13, further comprising a pressure sensor configured to capture a pressure reading while the UAV is in flight, wherein the UAV is configured to determine an altitude of the UAV based at least in part on the pressure reading.

15. The UAV of any of examples 6-14, further comprising a parachute, wherein the oversight processor is configured to deploy the parachute when the oversight processor determines the flight controller is operating in violation of the system parameters.

16. The UAV of any of examples 6-15, wherein:
the flight controller includes a first private key of first public key infrastructure (PKI) device credentials for verification of the system parameters by the flight controller, wherein the first PKI device credentials correspond to only the flight controller; and/or
the oversight processor includes a second private key of second PKI device credentials for verification of the system parameters by the oversight processor, wherein the second PKI device credential correspond to only the oversight processor.

17. A method of securing system parameters for an autonomously operating unmanned aerial vehicle (UAV), the method comprising:
generating a digital signature of the system parameters using a known credential authority, wherein the system parameters include operational envelope parameters that define an operational envelope for the autonomously operating UAV, wherein the operational envelope specifies airspace at a site of operation to which autonomous flight of the UAV is constrained;
encrypting the system parameters and the digital signature using a payload key; and
encrypting the payload key such that only a specific flight controller and/or a specific oversight processor of the autonomously operating UAV can decrypt the payload key to access, verify, and/or use the system parameters.

18. The method of example 17, wherein encrypting the payload key includes encrypting a copy of the payload key using a public key of public key infrastructure (PKI) device credentials, wherein the public key corresponds to a private key of the PKI device credentials, and wherein the private key is unique to a flight controller of the autonomously operating UAV.

19. The method of example 17 or example 18, wherein encrypting the payload key includes encrypting a copy of the payload key using a public key of public key infrastructure (PKI) device credentials, wherein the public key corresponds to a private key of the PKI device credentials, and wherein the private key is unique to an oversight processor of the autonomously operating UAV.

20. The method of any of examples 17-19, further comprising providing the autonomously operating UAV with a secure system parameters package, wherein the secure system parameters package includes:
a secure system parameters file having the encrypted system parameters and the encrypted digital signature;
a first file having a first copy of the payload key that is encrypted with a first public key of first public key infrastructure (PKI) device credentials, wherein the first public key corresponds to a first private key of the first PKI device credentials, and wherein the first private key is unique to a flight controller of the autonomously operating UAV; and
a second file having a second copy of the payload key that is encrypted with a second public key of second PKI device credentials, wherein the second public key corresponds to a second private key of the second PKI device credentials, and wherein the second private key is unique to an oversight processor of the autonomously operating UAV.

21. The method of example 20, wherein providing the autonomously operating UAV with the secure system parameters package includes:
remotely saving the secure system parameters package to first non-volatile memory permanently resident onboard the autonomously operating UAV; and/or
saving the secure system parameters package to second non-volatile memory separate from the autonomously operating UAV and removably providing the autonomously operating UAV with the second non-volatile memory.

22. A method of operating a UAV, the method comprising:
retrieving system parameters from non-volatile memory permanently resident onboard the UAV and/or removably provided to the UAV;
verifying the system parameters; and
autonomously executing a flight plan only after successfully verifying the system parameters.

23. The method of example 22, wherein:
retrieving the system parameters includes retrieving, using an oversight processor of the UAV, (i) a secure system parameters file including the system parameters and a digital signature, and (ii) an encrypted file including a payload key; and
verifying the system parameters includes:
   decrypting, using the oversight processor, the encrypted file using a private key of public key infrastructure (PKI) device credentials corresponding to only the oversight processor,
   decrypting, using the oversight processor, the secure system parameters file using the payload key, and
   verifying, using the oversight processor, the digital signature using a public key of PKI data integrity signing credentials.

24. The method of example 23, further comprising holding, using the oversight processor, a flight controller of the UAV in reset until the oversight processor verifies the system parameters.

25. The method of any of examples 22-24, wherein:
retrieving the system parameters includes retrieving, using a flight controller of the UAV, (i) a secure system parameters file including the system parameters and a digital signature, and (ii) an encrypted file including a payload key; and
verifying the system parameters includes:
   decrypting, using the flight controller, the encrypted file using a private key of public key infrastructure (PKI) device credentials corresponding to only the flight controller,
   decrypting, using the flight controller, the secure system parameters file using the payload key, and
verifying, using the flight controller, the digital signature using a public key of PKI data integrity signing credentials.

26. The method of any of examples 22-25, further comprising preventing the UAV from autonomously executing the flight plan when a flight controller and/or an oversight processor of the UAV is unable to verify the system parameters.

27. The method of any of examples 22-26, wherein the retrieving and the verifying are performed at least in part in response to receiving an indication that the UAV is powering on.

28. The method of any of examples 22-27, wherein autonomously executing the flight plan includes:
determining a position of the UAV using a first localization system of the UAV, wherein the position of the UAV determined using the first localization system is a first position of the UAV;
determining a position of the UAV using a second localization system of the UAV, wherein the second localization system is different from and independent of the first localization system, and wherein the position of the UAV determined using the second localization system is a second position of the UAV;
executing an emergency action based at least in part on a difference between the first position and the second position exceeding a threshold.

29. The method of any of examples 22-28, wherein the system parameters include operational envelope parameters that define an operational envelope for the UAV, wherein the operational envelope specifies airspace at a site of operation to which autonomous flight of the UAV is constrained, and wherein autonomously executing the flight plan includes:
navigating, using a flight controller of the UAV, a flight path within the operational envelope, wherein the flight path is defined by the flight plan;
comparing, using an oversight processor of the UAV different from the flight controller, a position of the UAV to the operational envelope; and
executing, using the oversight processor, an emergency action based at least in part on a determination that the position of the UAV violates the operational envelope.

30. The method of example 29, wherein executing the emergency action using the oversight processor includes:
forcing execution of alternate instructions to reduce operational velocity;
asserting a reset line of the flight controller to interrupt functionality of the flight controller; and/or
deploying a parachute of the UAV.

### D. Conclusion

The above detailed descriptions of embodiments of the technology are not intended to be exhaustive or to limit the technology to the precise form disclosed above. Although specific embodiments of, and examples for, the technology are described above for illustrative purposes, various equivalent modifications are possible within the scope of the technology, as those skilled in the relevant art will recognize. For example, while steps are presented in a given order, alternative embodiments can perform steps in a different order. Furthermore, the various embodiments described herein can also be combined to provide further embodiments.

The systems and methods described herein can be provided in the form of tangible and non-transitory machine-readable medium or media (such as a hard disk drive, hardware memory, and/or another suitable medium) having instructions recorded thereon for execution by a processor or computer. The set of instructions can include various commands that instruct the computer or processor to perform specific operations such as the methods and processes of the various embodiments described here. The set of instructions can be in the form of a software program or application. The computer storage media can include volatile and non-volatile media, and removable and non-removable media, for storage of information such as computer-readable instructions, data structures, program modules or other data. The computer storage media can include, but are not limited to, RAM, ROM, EPROM, EEPROM, flash memory or other solid-state memory technology, CD-ROM, DVD, or other optical storage, magnetic disk storage, or any other hardware medium which can be used to store desired information and that can be accessed by components of the system. Components of the system can communicate with each other via wired or wireless communication. The components can be separate from each other, or various combinations of components can be integrated together into a monitor or processor or contained within a workstation with standard computer hardware (for example, processors, circuitry, logic circuits, memory, and the like). The system can include processing devices such as microprocessors, microcontrollers, integrated circuits, control units, storage media, and other hardware.

From the foregoing, it will be appreciated that specific embodiments of the technology have been described herein for purposes of illustration, but well-known structures and functions have not been shown or described in detail to avoid unnecessarily obscuring the description of the embodiments of the technology. To the extent any materials incorporated herein by reference conflict with the present disclosure, the present disclosure controls. Where the context permits, singular or plural terms can also include the plural or singular term, respectively. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the phrase “and/or” as in “A and/or B” refers to A alone, B alone, and both A and B. Additionally, the terms “comprising,” “including,” “having” and “with” are used throughout to mean including at least the recited feature(s) such that any greater number of the same feature and/or additional types of other features are not precluded. Furthermore, as used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking, the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

From the foregoing, it will also be appreciated that various modifications can be made without deviating from the technology. For example, various components of the technology can be further divided into subcomponents, or various components and functions of the technology can be combined and/or integrated. Furthermore, although advantages associated with certain embodiments of the technology have been described in the context of those embodiments, other embodiments can also exhibit such advantages, and not all embodiments need necessarily exhibit such advantages to fall within the scope of the technology. Accordingly, the disclosure and associated technology can encompass other embodiments not expressly shown or described herein.

What is claimed is:

1. An autonomously operating unmanned aerial vehicle (UAV), comprising:
a flight controller configured to manage flight operations of the autonomously operating UAV;
an oversight processor configured to oversee the flight operations of the flight controller; and
a media interface operably connected to the flight controller and to the oversight processor,
wherein:
the flight controller and the oversight processor are each configured to (i) receive, over the media interface, system parameters stored in non-volatile memory, and (ii) verify the system parameters before executing autonomous flight operations, and
the system parameters include operational envelope parameters for the autonomously operating UAV defining an operational envelope that specifies airspace at a site of operation to which autonomous flight of the autonomously operating UAV is constrained.

2. The autonomously operating UAV of claim 1, wherein, to verify the system parameters, the flight controller and the oversight processor are each configured to:
decrypt a payload key using a device credential unique to only the flight controller or to only the oversight processor;
decrypt the system parameters using the decrypted payload key to extract the system parameters and a digital signature associated with the system parameters; and
verify the digital signature before using the system parameters.

3. The autonomously operating UAV of claim 1, wherein, based at least in part on an indication that the autonomously operating UAV is powering on, the oversight processor is further configured to hold the flight controller in reset until the oversight processor successfully verifies the system parameters.

4. The autonomously operating UAV of claim 1, further comprising a plurality of localization systems and a parachute, wherein:
each localization system of the plurality of localization systems is configured to determine a position of the autonomously operating UAV and to provide the position to the oversight processor;
the oversight processor is configured to (i) compare one or more positions determined by one or more localization systems of the plurality of localization systems to the operational envelope, and (ii) execute an emergency action when the oversight processor determines that the one or more positions violate the operational envelope for the UAV; and
the emergency action includes (i) asserting a reset pin of the flight controller to cease functionality of the flight controller and (ii) deploying the parachute.

5. The autonomously operating UAV of claim 1, further comprising a plurality of localization systems, wherein:
each localization system of the plurality of localization systems is configured to determine a position of the autonomously operating UAV and to provide the position to the flight controller; and
the flight controller is configured to (i) determine a difference between a first position of the autonomously operating UAV determined by a first localization system of the plurality of localization systems and a second position of the autonomously operating UAV determined by a second localization system of the plurality of localization systems, and (ii) execute an emergency action when the difference exceeds a threshold.

6. An unmanned aerial vehicle (UAV), comprising:
a flight controller configured to control flight operations of the UAV based at least in part on system parameters provided to the UAV; and
an oversight processor different from the flight controller and configured to (i) monitor operations of the flight controller and (ii) intercede when the oversight processor determines the flight controller is operating in violation of the system parameters.

7. The UAV of claim 6, further comprising a shared media interface, wherein the shared media interface is configured to operably connect non-volatile memory storing the system parameters to the flight controller and to the oversight processor.

8. The UAV of claim 7, further comprising the non-volatile memory, wherein the non-volatile memory is configured to provide the system parameters to the flight controller and the oversight processor over the shared media interface.

9. The UAV of claim 6, wherein the system parameters include operational envelope parameters that define an operational envelope for the UAV, and wherein the operational envelope for the UAV specifies airspace at a site of operation within which flight of the UAV is constrained.

10. The UAV of claim 6, further comprising a plurality of localization systems, wherein each localization system in the plurality of localization systems is configured to determine a position of the UAV independent of other localization systems of the plurality of localization systems.

11. The UAV of claim 10, wherein the plurality of localization systems includes a global positioning system (GPS) and a radiofrequency (RF) localization system.

12. The UAV of claim 10, wherein each localization system of the plurality of localization systems is configured to provide the position of the UAV to the flight controller and to the oversight processor.

13. The UAV of claim 10, wherein the plurality of localization systems includes:
a first subset of localization systems configured to provide the position of the UAV to only the flight controller; and
a second subset of localization systems configured to provide the position of the UAV to only the oversight processor.

14. The UAV of claim 6, further comprising a pressure sensor configured to capture a pressure reading while the UAV is in flight, wherein the UAV is configured to determine an altitude of the UAV based at least in part on the pressure reading.

15. The UAV of claim 6, further comprising a parachute, wherein the oversight processor is configured to deploy the parachute when the oversight processor determines the flight controller is operating in violation of the system parameters.

16. The UAV of claim 6, wherein:
the flight controller includes a first private key of first public key infrastructure (PKI) device credentials for verification of the system parameters by the flight controller, wherein the first PKI device credentials correspond to only the flight controller; and/or
the oversight processor includes a second private key of second PKI device credentials for verification of the system parameters by the oversight processor, wherein the second PKI device credential correspond to only the oversight processor.

17. A method of securing system parameters for an autonomously operating unmanned aerial vehicle (UAV), the method comprising:
generating a digital signature of the system parameters using a known credential authority, wherein the system parameters include operational envelope parameters that define an operational envelope for the autonomously operating UAV, wherein the operational envelope specifies airspace at a site of operation to which autonomous flight of the UAV is constrained;
encrypting the system parameters and the digital signature using a payload key; and
encrypting the payload key such that only a specific flight controller and/or a specific oversight processor of the autonomously operating UAV can decrypt the payload key to access, verify, and/or use the system parameters.

18. The method of claim 17, wherein encrypting the payload key includes encrypting a copy of the payload key using a public key of public key infrastructure (PKI) device credentials, wherein the public key corresponds to a private key of the PKI device credentials, and wherein the private key is unique to a flight controller of the autonomously operating UAV.

19. The method of claim 17, wherein encrypting the payload key includes encrypting a copy of the payload key using a public key of public key infrastructure (PKI) device credentials, wherein the public key corresponds to a private key of the PKI device credentials, and wherein the private key is unique to an oversight processor of the autonomously operating UAV.

20. The method of claim 17, further comprising providing the autonomously operating UAV with a secure system parameters package, wherein the secure system parameters package includes:
a secure system parameters file having the encrypted system parameters and the encrypted digital signature;
a first file having a first copy of the payload key that is encrypted with a first public key of first public key infrastructure (PKI) device credentials, wherein the first public key corresponds to a first private key of the first PKI device credentials, and wherein the first private key is unique to a flight controller of the autonomously operating UAV; and
a second file having a second copy of the payload key that is encrypted with a second public key of second PKI device credentials, wherein the second public key corresponds to a second private key of the second PKI device credentials, and wherein the second private key is unique to an oversight processor of the autonomously operating UAV.

21. The method of claim 20, wherein providing the autonomously operating UAV with the secure system parameters package includes:
remotely saving the secure system parameters package to first non-volatile memory permanently resident onboard the autonomously operating UAV; and/or
saving the secure system parameters package to second non-volatile memory separate from the autonomously operating UAV and removably providing the autonomously operating UAV with the second non-volatile memory.

22. A method of operating a UAV, the method comprising:
retrieving system parameters from non-volatile memory permanently resident onboard the UAV and/or removably provided to the UAV;
verifying the system parameters; and
autonomously executing a flight plan only after successfully verifying the system parameters.

23. The method of claim 22, wherein:
retrieving the system parameters includes retrieving, using an oversight processor of the UAV, (i) a secure system parameters file including the system parameters and a digital signature, and (ii) an encrypted file including a payload key; and
verifying the system parameters includes:
decrypting, using the oversight processor, the encrypted file using a private key of public key infrastructure (PKI) device credentials corresponding to only the oversight processor,
decrypting, using the oversight processor, the secure system parameters file using the payload key, and
verifying, using the oversight processor, the digital signature using a public key of PKI data integrity signing credentials.

24. The method of claim 23, further comprising holding, using the oversight processor, a flight controller of the UAV in reset until the oversight processor verifies the system parameters.

25. The method of claim 22, wherein:
retrieving the system parameters includes retrieving, using a flight controller of the UAV, (i) a secure system parameters file including the system parameters and a digital signature, and (ii) an encrypted file including a payload key; and
verifying the system parameters includes:
decrypting, using the flight controller, the encrypted file using a private key of public key infrastructure (PKI) device credentials corresponding to only the flight controller,
decrypting, using the flight controller, the secure system parameters file using the payload key, and
verifying, using the flight controller, the digital signature using a public key of PKI data integrity signing credentials.

26. The method of claim 22, further comprising preventing the UAV from autonomously executing the flight plan when a flight controller and/or an oversight processor of the UAV is unable to verify the system parameters.

27. The method of claim 22, wherein the retrieving and the verifying are performed at least in part in response to receiving an indication that the UAV is powering on.

28. The method of claim 22, wherein autonomously executing the flight plan includes:
determining a position of the UAV using a first localization system of the UAV, wherein the position of the UAV determined using the first localization system is a first position of the UAV;
determining a position of the UAV using a second localization system of the UAV, wherein the second localization system is different from and independent of the first localization system, and wherein the position of the UAV determined using the second localization system is a second position of the UAV;
executing an emergency action based at least in part on a difference between the first position and the second position exceeding a threshold.

29. The method of claim 22, wherein the system parameters include operational envelope parameters that define an operational envelope for the UAV, wherein the operational envelope specifies airspace at a site of operation to which autonomous flight of the UAV is constrained, and wherein autonomously executing the flight plan includes:
navigating, using a flight controller of the UAV, a flight path within the operational envelope, wherein the flight path is defined by the flight plan;
comparing, using an oversight processor of the UAV different from the flight controller, a position of the UAV to the operational envelope; and
executing, using the oversight processor, an emergency action based at least in part on a determination that the position of the UAV violates the operational envelope.

30. The method of claim 29, wherein executing the emergency action using the oversight processor includes:
forcing execution of alternate instructions to reduce operational velocity;
asserting a reset line of the flight controller to interrupt functionality of the flight controller; and/or
deploying a parachute of the UAV.
